(19) United States
(12) Patent Application Publication
(10) Pub. No.: US 2026/0079647 A1
(43) Pub. Date: Mar. 19, 2026

(54) INFORMATION PROCESSING SYSTEM AND MEMORY SYSTEM

(71) Applicant: Kioxia Corporation, Tokyo (JP)

(72) Inventors: Takumi FUJIMORI, Yamato (JP); Tetsuya SUNATA, Yokohama (JP); Yohei HASEGAWA, Fuchu (JP)

(73) Assignee: Kioxia Corporation, Tokyo (JP)

(21) Appl. No.: 19/077,571

(22) Filed: Mar. 12, 2025

(30) Foreign Application Priority Data
Sep. 18, 2024 (JP) 2024-161014

(51) Int. Cl. G06F 3/06

(52) U.S. Cl. CPC G06F 3/0659; G06F 3/0616; G06F 3/0619; G06F 3/065; G06F 3/0688

(57) ABSTRACT

According to one embodiment, an information processing system includes a plurality of memory systems and a storage controller. The storage controller assigns a first identifier and a second identifier to a first write request requesting writing of original data and a second write request requesting writing of mirror data, respectively. A controller of each of the memory systems writes first data to a first write destination block in response to determining that an identifier contained in a write request received from the storage controller is the first identifier, and writes the first data to a second write destination block in response to determining that the identifier contained in the write request is the second identifier.

### CROSS-REFERENCE TO RELATED APPLICATIONS

This application is based upon and claims the benefit of priority from Japanese Patent Application No. 2024-161014, filed Sep. 18, 2024, the entire contents of which are incorporated herein by reference.

### FIELD

Embodiments described herein relate generally to an information processing system and a memory system.

### BACKGROUND

Memory systems including a nonvolatile memory and a controller are known.

In such memory systems, if different types of data are mixed in the same block of the nonvolatile memory, the efficiency of garbage collection is decreased, resulting in increase of write amplification.

In the meantime, information processing systems that include multiple memory systems, redundant arrays of independent disks (RAID) are used in some cases to improve resistance to memory system failures. But, even in information processing systems that use RAID, the write amplification of each memory system may become large.

### BRIEF DESCRIPTION OF THE DRAWINGS

FIG. 1 is a block diagram illustrating a configuration example of a memory system according to a first embodiment.

FIG. 2 is a block diagram illustrating a configuration example of an information processing system according to the first embodiment.

FIG. 3A is a flowchart illustrating an example of a procedure for write control processing executed by a storage controller according to the first embodiment.

FIG. 3B is a flowchart illustrating an example of a procedure for write control processing executed by the memory system according to the first embodiment.

FIG. 4 is a block diagram illustrating a block diagram illustrating a configuration example of an information processing system according to a second embodiment.

FIG. 5 is a flowchart illustrating an example of a procedure for RAID level conversion processing executed by a storage controller according to the second embodiment.

FIG. 6 is a block diagram illustrating a configuration example of a memory system according to the third embodiment.

FIG. 7 is a block diagram illustrating a configuration example of an information processing system according to the third embodiment.

FIG. 8 is a flowchart illustrating an example of a procedure for write processing executed by the memory system according to the third embodiment.

FIG. 9 is a flowchart illustrating an example of a procedure for first RAID level conversion processing executed by the memory system according to the third embodiment.

FIG. 10 is a flowchart illustrating an example of a procedure for second RAID level conversion processing executed by the memory system according to the third embodiment.

FIG. 11 is a flowchart illustrating an example of a procedure for third RAID level conversion processing executed by the memory system according to the third embodiment.

FIG. 12 is a block diagram illustrating the read control process executed in the memory system of the third embodiment.

FIG. 13 is a flowchart illustrating an example of the procedure for a read control process executed in the memory system of the third embodiment.

FIG. 14 is a block diagram illustrating a configuration example of an information processing system according to the fourth embodiment.

### DETAILED DESCRIPTION

Various embodiments will be described hereinafter with reference to the accompanying drawings.

In general, according to one embodiment, an information processing system comprises a plurality of memory systems and a storage controller configured to control the plurality of memory systems. The storage controller assigns a first identifier and a second identifier to a first write request requesting writing of original data and a second write request requesting writing of mirror data which is a duplicate of the original data, respectively. The first identifier indicates that data to be written is the original data, the second identifier indicates that data to be written is the mirror data. The storage controller transmits the first write request including the first identifier to one of the plurality of memory systems, and transmits the second write request including the second identifier to another one of the plurality of memory systems. Each of the plurality of memory systems includes a nonvolatile memory that includes a plurality of blocks, each of the plurality of block being a unit of a data erase operation; and a controller configured to control the nonvolatile memory. The controller manages a first write destination block to which the original data is to be written and a second write destination block to which the mirror data is to be written. In response to receiving, from the storage controller, a write request requesting writing of first data, the controller determines whether an identifier contained in the received write request is the first identifier or the second identifier. In response to determining that the identifier contained in the received write request is the first identifier, the controller writes the first data to the first write destination block. In response to determining that the identifier contained in the received write request is the second identifier, the controller writes the first data to the second destination block.

### First Embodiment

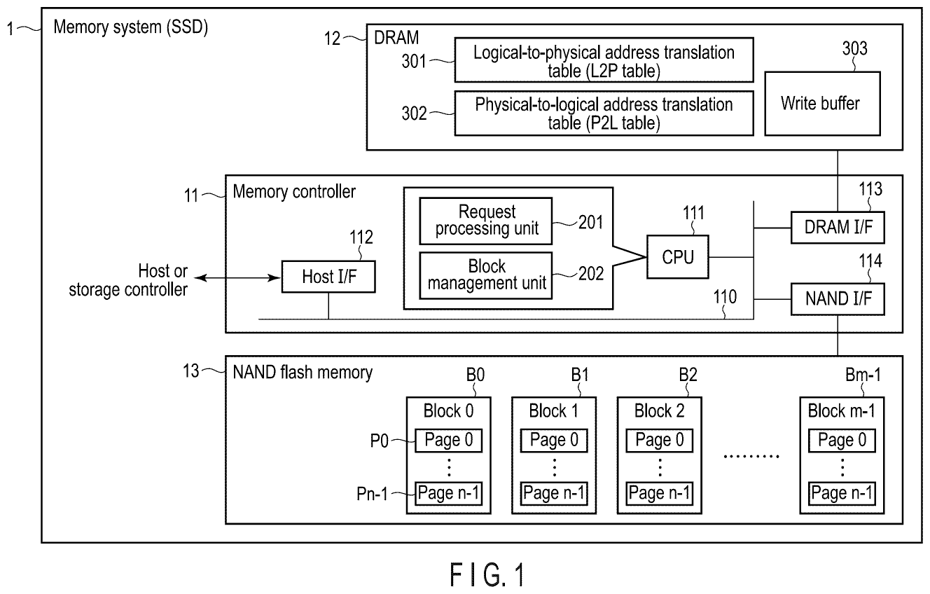

FIG. 1 is a block diagram illustrating a configuration example of a memory system 1 of the first embodiment. The memory system 1 is a semiconductor storage device such as a universal flash storage (UFS) or a solid state drive (SSD). Hereinafter, the memory system 1 will be described as an SSD 1.

The SSD 1 can be connected to an external host or external storage controller, and based on requests from the host or storage controller, it executes write control processing to write data to a nonvolatile memory contained in the SSD 1 and read control processing to read data from the nonvolatile memory.

The SSD 1 includes a memory controller 11, a dynamic random access memory (DRAM) 12, and a nonvolatile memory 13. The nonvolatile memory 13 is, for example, a NAND flash memory. In the following descriptions, the nonvolatile memory 13 is referred to as a NAND flash memory 13.

The memory controller 11 is a controller having circuitry, and is realized, for example, as an LSI such as a system-on-a-chip (SoC).

The memory controller 11 functions as a flash translation layer (FTL) configured to perform data management of the NAND flash memory 13 and block management of the NAND flash memory 13. The data management performed by this FTL includes: (1) management of mapping information, which is information indicating the correspondence relationship between each of logical addresses and each of physical addresses of the NAND flash memory 13; and (2) processing to hide the difference between data read operation/data write operation per page and data erase operation per block. The block management includes bad block management, wear leveling, and garbage collection.

The management of the mapping between each logical address and each physical address is performed using a logical-to-physical address translation table (L2P table) 301. The memory controller 11 uses the L2P table 301 to manage the mapping between each logical address and each physical address in units of a specific management size. The L2P table 301 is used to convert a logical address to a physical address corresponding to the logical address. A physical address corresponding to a logical address indicates the physical storage location within the NAND flash memory 13 where data corresponding to this logical address is written. The L2P table 301 may be loaded from the NAND flash memory 13 to the DRAM 12 when the SSD 1 is powered on.

Writing of data to one page of the NAND flash memory 13 is only able to be performed once per program/erase cycle. For this reason, the memory controller 11 writes updated data corresponding to a certain logical address to a different physical storage location rather than to the physical storage location where the previous data corresponding to this logical address is stored. The memory controller 11 then invalidates the previous data by updating the L2P table 301 to associate this logical address with this other physical storage location. The data referenced from the L2P table 301 (that is, the data associated with a logical address) is referred to as valid data. The data that is not associated with any logical address is referred to as invalid data. Valid data is data that may be read from the host 2 at a later time. Invalid data is data that is no longer likely to be read from the host 2.

Further, the memory controller 11 also executes processing of converting a physical address to a logical address corresponding to the data written to that physical address by referring to the physical-to-logical address translation table (P2L table) 302. The P2L table 302 may as well be referred to as a reverse lookup table.

The NAND flash memory 13 includes a plurality of physical blocks B0, B1, B2, . . . , and Bm−1. Each of the physical blocks B0, B1, B2, . . . , Bm−1 includes a plurality of pages P0, . . . , Pn−1. Each of the physical blocks B0, B1, B2, . . . , Bm−1 is a minimum unit of data erase operation. The physical block may as well be referred in some cases to as a “memory block”, “erase block”, or simply “block”. Each of the pages P0, . . . , Pn−1 includes a plurality of memory cells connected to a single word line. Each of the pages P0, . . . , Pn−1 is a unit of each of data write operation and data read operation.

The number of program/erase cycles (P/E cycles) for each physical block is limited, and is referred to as the maximum P/E cycle count. A single P/E cycle for a physical block includes a data erase operation to set all memory cells in this physical block to an erase state, and a data write operation (program operation) to write data to each of pages of this physical block.

The data erase operation may be performed in units of a super block that bundles a plurality of physical blocks. For example, a single super block includes a plurality of physical blocks which are selected from among a plurality of memory chips included in the NAND-type flash memory 13, respectively. Note here that a configuration in which one superblock contains one physical block may as well be used, in which case one superblock is equivalent to one physical block. In this embodiment, as a group of physical resources for data writing, a plurality of blocks, each of which is the unit of data erase operation, are used. Each block may be a physical block or a superblock.

The DRAM 12 is volatile memory. The DRAM 12 includes, for example, a storage area of the L2P table 301, a storage area of the P2L table 302, and a write buffer 303 which temporarily stores write data.

Next, a configuration of the memory controller 11 will be explained.

The memory controller 11 includes, for example, a CPU 111, a host interface (host I/F) 112, a DRAM interface (DRAM I/F) 113, and a NAND interface (NAND I/F) 114. The CPU 111, the host I/F 112, the DRAM I/F 113, and the NAND I/F 114 are interconnected via an internal bus 110, for example.

The CPU 111 is a processor configured to control the host I/F 112, the NAND I/F 114, and the DRAM I/F 113. The CPU 111 performs various processes by executing the firmware loaded from the NAND flash memory 13 to the DRAM 12. The firmware is a control program that includes a group of instructions for causing the CPU 111 to perform various processes. The CPU 111 can execute various requests (commands) from an external host or external storage controller. The operation of the CPU 111 is controlled by the firmware executed by the CPU 111.

The functions of the components in the memory controller 11 may be implemented by dedicated hardware in the memory controller 11, or by the CPU 111 executing firmware.

The host I/F 112 functions as a circuit that receives various requests and data from a host or storage controller via a PCIe bus or network. Further, the host I/F 112 functions as a circuit that sends responses to requests and data to a host or storage controller via a PCIe bus or network. Furthermore, the host I/F 112 may as well function as a circuit that transmits various requests, data, and responses to one or more other SSDs via the PCIe bus or network. Moreover, the host interface 112 may as well function as a circuit that receives various requests, data, and responses from one or more other SSDs via the PCIe bus or network.

The DRAM I/F 113 functions as a DRAM control circuit configured to control the accessing to the DRAM 12.

The NAND I/F 114 is a NAND control circuit configured to control the NAND flash memory 13. The NAND I/F 114 supports interface standards such as Toggle DDR, Open NAND Flash Interface (ONFI) and the like. The NAND I/F 114 may be connected to multiple memory chips in the NAND flash memory 13 via multiple channels, respectively. By driving the multiple memory chips in parallel, it is possible to widen the bandwidth of accessing to the NAND flash memory 13.

Next, a functional configuration of the CPU 111 will be explained.

The CPU 111 includes a request processing unit 201 and a block management unit 202. Each of the request processing unit 201 and the block management unit 202 is implemented, for example, by firmware. Alternatively, each of the request processing unit 201 and the block management unit 202 may as well be implemented by dedicated hardware included in the memory controller 11.

The request processing unit 201 accepts requests sent from the host, storage controller, or another SSD. The request processing unit 201 performs write control processing, read control processing, and various other processes based on the requests it has received.

The block management unit 202 manages multiple blocks included in the NAND flash memory 13. Details of the configuration of the block management unit 202 will be described later.

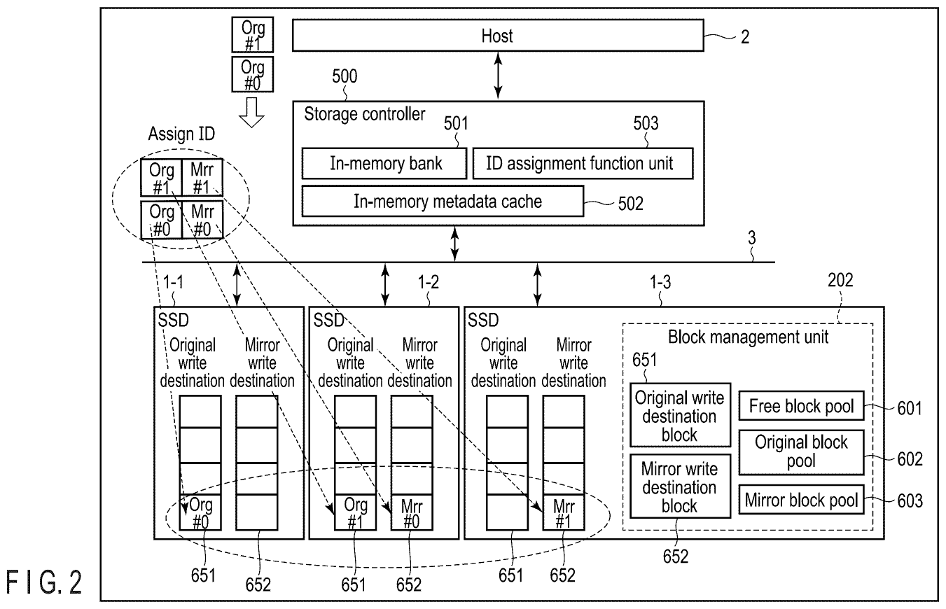

Next, the configuration of the information processing system according to the first embodiment will be explained. FIG. 2 is a block diagram illustrating an example of the configuration of the information processing system according to the first embodiment.

The information processing system includes a host 2, a storage controller 500, and a plurality of SSDs 1 (here, SSD 1-1, SSD 1-2, and SSD 1-3).

The host 2 is an information processing device such as a server or a personal computer.

The storage controller 500 is, for example, a RAID controller. The storage controller 500 is implemented as a device that can be connected to the host 2. Note that the storage controller 500 may as well be implemented as hardware built in the host 2.

The storage controller 500 and the SSD 1-1, SSD 1-2, and SSD 1-3 are connected to the communication path 3. The communication path 3 is implemented using a network or PCIe bus, for example. In the case where the communication path 3 is implemented using a PCIe bus, the storage controller 500 is connected to a PCIe switch via the corresponding PCIe bus. Each of the SSD 1-1, SSD 1-2, and SSD 1-3 as well is connected to the PCIe switch via the corresponding PCIe bus.

The storage controller 500 controls multiple SSDs 1 (here, SSD 1-1, SSD 1-2, and SSD 1-3) as an SSD array using a RAID level 1 (mirroring) or RAID level 5 (erasure coding). Note that a RAID level 6 may be used in place of the RAID level 5.

In the first embodiment, the storage controller 500 controls data writing to multiple SSDs 1 (SSD array) using mirroring. Note that the storage controller 500 can perform RAID level conversion processing as well. The RAID level conversion processing is a process that converts the RAID level for the multiple SSDs 1 from a level corresponding to the mirroring (RAID-1) to a level corresponding to the erasure coding (RAID-5). Details of the RAID level conversion processing will be explained in the second embodiment.

The storage controller 500 includes an in-memory bank 501, an in-memory metadata cache 502, and an identifier assignment function unit 503.

The in-memory bank 501 is a storage area in the DRAM of the storage controller 500. The in-memory bank 501 is used to hold a predetermined amount of data to be written to the SSD array or data read from the storage array.

The in-memory metadata cache 502 as well is a storage area in the DRAM of the storage controller 500. The in-memory metadata cache 502 is used to store metadata for each piece of data written to the storage array.

The identifier assignment function unit 503 assigns an identifier to the write request sent from the storage controller 500 to the SSD array. The identifier indicates the type of data to be written. That is, the identifier assignment function unit 503 assigns an identifier indicating that the data to be written is original data, that is, an identifier indicating that the original data is to be written, to the write request requesting the writing of original data. Here, the original data is the data specified in the write request from the host 2. Further, the identifier assignment function unit 503 assigns an identifier indicating that the data to be written is mirror data, that is, an identifier indicating that mirror data is to be written, to a write request that requests the writing of mirror data, which is a duplicate of the original data. Thus, either one of two types of identifiers is assigned to each of the write requests.

When performing mirror writing, the storage controller 500 sends a write request requesting the writing of the original data and one or more write requests requesting the writing of mirror data, which is a duplicate of the original data, to different SSDs 1 in the SSD array. In this case, the write request requesting the writing of the original data is given an identifier indicating that the original data is to be written. On the other hand, each of the one or more write requests of requesting the writing of mirror data is given an identifier indicating that mirror data is to be written. An example of the processing for mirror writing will now be explained. The following explanation is based on the assumption that the number of mirror data per original data is 1.

Upon receiving a write request for data (original data Org #0) from the host 2, the storage controller 500 duplicates the write request thus received and generates a write request that requests the wiring of mirror data Mrr #0, which is a duplicate of the original data Org #0. The received write request includes the logical address corresponding to the original data Org #0.

The storage controller 500 determines the SSD (for example, SSD 1-1) to which the original data Org #0 is to be written and the SSD (for example, SSD 1-2) to which the mirror data Mrr #0 is to be written. The storage controller 500 assigns an identifier (the first identifier) indicating that the original data is to be written to the received write request (the write request for the original data Org #0), and also assigns an identifier (the second identifier) which indicates that the mirror data is to be written to the generated write request (the write request for the mirror data Mrr #0). Then, the storage controller 500 sends a write request for the original data Org #0, which includes the first identifier, to the SSD 1-1, and sends a write request for the mirror data Mrr #0, which includes the second identifier, to the SSD 1-2.

The write request for the original data Org #0 includes the logical address corresponding to the original data Org #0 and the first identifier. The write request for the original data Org #0 may as well include a data pointer indicating the location within the in-memory bank 501 where the original data Org #0 is stored. The write request for the mirror data Mrr #0 includes a logical address corresponding to the original data Org #0 and the second identifier. Further, the write request for the mirror data Mrr #0 may as well include a data pointer indicating the location within the in-memory bank 501 where the original data Org #0 is stored.

In the case where the write request for the original data Org #0 includes a data pointer, the memory controller 11 of the SSD 1-1 can acquire the original data Org #0 from the in-memory bank 501. Further, in the case where the write request for the mirror data Mrr #0 includes a data pointer, the memory controller 11 of the SSD 1-2 can acquire the original data Org #0 from the in-memory bank 501 as mirror data Mrr #0.

After completing of the writing of the original data Org #0 and the mirror data Mrr #0, the storage controller 500 generates metadata for the original data Org #0 and stores the thus generated metadata in the in-memory metadata cache 502. The metadata for the original data Org #0 includes information for managing the SSDs to which the original data Org #0 and the mirror data Mrr #0 are respectively allocated. The metadata of the original data Org #0, for example, includes the logical address corresponding to the original data Org #0, the identifier (device ID 0) of the SSD 1-1 on which the original data Org #0 is written, and the identifier (device ID 1) of SSD 1-2 on which the mirror data Mrr #0 is written.

Upon receiving a write request for the next data (original data Org #1) from the host 2, the storage controller 500 duplicates this write request and generates a write request that requests the writing of the mirror data Mrr #1, which is a duplicate of the original data Org #1. The write request for the original data Org #1 includes the logical address corresponding to the original data Org #1.

The storage controller 500 determines the SSD (for example, SSD 1-2) to which the original data Org #1 is to be written and the SSD (for example, SSD 1-3) to which the mirror data Mrr #1 is to be written. The storage controller 500 assigns the first identifier to the write request for the original data Org #1 and the second identifier to the write request for the mirror data Mrr #1. Then, the storage controller 500 sends the write request for the original data Org #1, which includes the first identifier, to the SSD 1-2, and sends the write request for the mirror data Mrr #1, which includes the second identifier, to the SSD 1-3.

The write request for the original data Org #1 includes the logical address corresponding to the original data Org #1 and the first identifier. The write request for the original data Org #1 may as well include a data pointer indicating the location within the in-memory bank 501 where the original data Org #1 is stored. The write request for mirror data Mrr #1 includes a logical address corresponding to the original data Org #1 and a second identifier. The write request for mirror data Mrr #1 may as well include a data pointer indicating the location within the in-memory bank 501 where the original data Org #1 is stored.

In the case where the write request for the original data Org #1 includes a data pointer, the memory controller 11 of the SSD 1-2 can acquire the original data Org #1 from the in-memory bank 501. Further, in the case where the write request for mirror data Mrr #1 includes a data pointer, the memory controller 11 of the SSD 1-3 can acquire the original data Org #1 from in-memory bank 501 as mirror data Mrr #1.

After completion of the writing of the original data Org #1 and the mirror data Mrr #1, the storage controller 500 generates metadata for the original data Org #1 and stores the thus generated metadata in the in-memory metadata cache 502. The metadata for the original data Org #1 is information used to manage the SSDs where the original data Org #1 and the mirror data Mrr #1 are stored. The metadata for the original data Org #1 includes, for example, the logical address corresponding to the original data Org #1, the identifier (device ID1) of the SSD 1-2 where the original data Org #1 is written, and the identifier (device ID2) of the SSD 1-3 where the mirror data Mrr #1 is written.

As described above, the storage controller 500 assigns an identifier indicating whether the data associated with the write request is original data or mirror data, to a write request to be issued to the SSD array, and transmits the write request including this identifier to which the SSD is to be written to in the SSD array. Therefore, each SSD 1 can determine whether the data associated with the write request received from the storage controller 500 is the original data or mirror data.

Here, the configuration of the block management unit 202 of each of the SSD 1-1, SSD 1-2, and SSD 1-3 will be explained.

The block management unit 202 includes a free block pool 601, an original block pool 602, and a mirror block pool 603.

The free block pool 601 is a list (list of block IDs) of identifiers for each free block, which is a block that does not contain valid data. The block management unit 202 uses the free block pool 601 to manage each free block (free physical block or free super block) of the NAND flash memory 13.

The original block pool 602 is a list of identifiers (a list of block IDs) for each original block, which is a block to which the original data has been written. The block management unit 202 uses the original block pool 602 to manage each original block (original physical block or original super block) of the NAND flash memory 13.

The mirror block pool 603 is a list (list of block IDs) of identifiers for each mirror block, which is a block to which the mirror data has already been written. The block management unit 202 uses the mirror block pool 603 to manage each mirror block (mirror physical block or mirror super block) of the NAND flash memory 13.

The block management unit 202 allocates one free block (free physical block or free super block) of the NAND flash memory 13 as an original write destination block 651, and allocates another free block (free physical block or free super block) of the NAND flash memory 13 as a mirror write destination block 652. The original write destination block 651 is the destination block to which the original data should be written. The mirror write destination block 652 is the destination block to which the original data should be written.

When the entire original write destination block 651 is filled with original data, the original write destination block 651 is managed as an original block in the original block pool 602, and in place, one of the free blocks is allocated as a new original write destination block 651.

When the entire mirror write destination block 652 is filled with mirror data, the mirror write destination block 652 is managed as a mirror block in the mirror block pool 602, and in place, one of the free blocks is allocated as a new mirror write destination block 652.

In this way, the memory controller 11 of each of the SSD 1-1, SSD 1-2, and SSD 1-3 manages the write destination block to which the original data should be written (original write destination block 651) and the write destination block to which the mirror data should be written (mirror write destination block 652).

When a write request is received from the storage controller 500, the memory controller 11 of each of the SSD 1-1, SSD 1-2, and SSD 1-3 determine whether the identifier contained in the received write request is the first identifier or the second identifier. In the case where the identifier contained in the received write request is the first identifier, the memory controller 11 selects the original write destination block 651 and writes the data (original data) associated with the received write request to the original write destination block 651. On the other hand, in the case where the identifier contained in the received write request is the second identifier, the memory controller 11 selects the mirror write destination block 652 and writes the data associated with the received write request (mirror data) to the mirror write destination block 652.

In the example of FIG. 2, the write request for the original data Org #0 is sent to the SSD 1-1, and therefore the original data Org #0 is written to the original write destination block 651 of the SSD 1-1. The write request for the mirror data Mrr #0 is sent to the SSD 1-2, and therefore the mirror data Mrr #0 is written to the mirror write destination block 652 of the SSD 1-2.

Similarly, the original data Orig #1 is written to the original write destination block 651 of the SSD 1-2, and the mirror data Mrr #1 is written to the mirror write destination block 652 of the SSD 1-3.

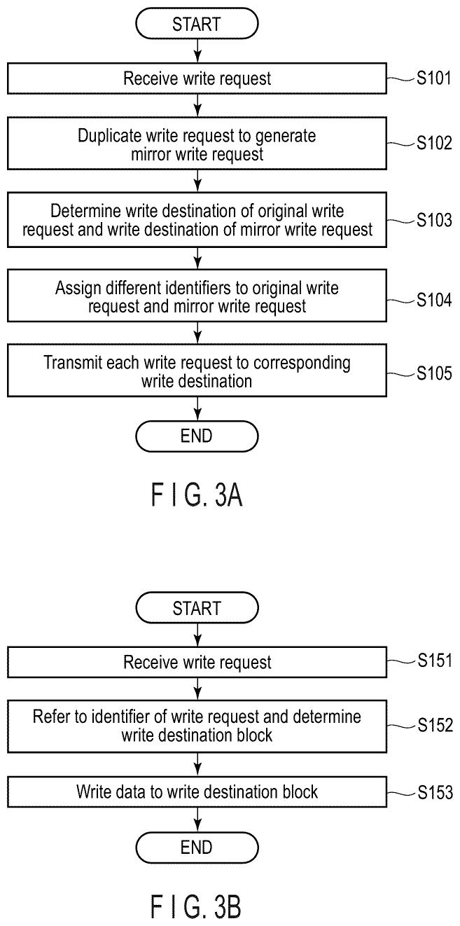

Next, the write control processing executed in the storage controller 500 will be explained. FIG. 3A is a flowchart illustrating an example of the procedure for the write control processing executed in the storage controller 500.

First, the storage controller 500 receives a write request (original write request) from the host 2 (step S101). The storage controller 500 duplicates the received original write request (step S102). Hereinafter, the write request generated by duplication is referred to as a mirror write request.

Next, the storage controller 500 determines the SSD 1 (hereinafter referred to as the “original destination SSD 1”) to which data should be written in response to the original write request and the SSD 1 (hereinafter referred to as the “mirror write destination SSD 1”) to which data should be written in response to the mirror write request (step S103). The original destination SSD 1 and the mirror write destination SSD 1 are SSDs 1 different from each other. The storage controller 500 assigns different identifiers to the original write request and the mirror write request, respectively (step S104). Specifically, the storage controller 500 assigns an identifier (first identifier) indicating that original data should be written to the original write request. Further, the storage controller 500 assigns an identifier (second identifier) indicating that mirror data should be written to the mirror write request.

Then, the storage controller 500 sends the original write request to the original write destination SSD 1 and sends the mirror write request to the mirror write destination SSD 1 (step S105), thus finishing the write control processing.

With the above-described write control processing, the storage controller 500 can inform each SSD 1 whether the data associated with each individual write request issued to the SSD array is original data or mirror data.

FIG. 3B is a flowchart illustrating an example of the procedure for the write processing executed in the SSD 1.

First, the memory controller 11 of the SSD 1 receives a write request from the storage controller 500 via the host I/F 112 (step S151). The memory controller 11 refers to the identifier contained in the received write request and determines the destination block to which the data associated with the received write request should be written (step S152). Specifically, in the case where the identifier of the write request is the first identifier, the memory controller 11 determines the original write destination block 651 as the write destination block. On the other hand, in the case where the identifier of the write request is the second identifier, the memory controller 11 determines the mirror write destination block 652 as the write destination block.

The memory controller 11 writes the data associated with the received write request to the determined write destination block (step S153) and finishes the write control processing.

With the above-described write control processing, the memory controller 11 can write the original data and mirror data to different blocks, respectively.

In a cash were each of the write requests for mirror data Mrr #0 and write requests for original data Org #1 does not include an identifier, the memory controller 11 of the SSD 1-2 is not able to determine whether the data associated with these write requests is original data or mirror data. As a result, the mirror data Mrr #0 and the original data Org #1 are written to the same block. As the mirror write process progresses, this block is filled with many original data and many mirror data. Then, when only the mirror data is invalidated, about half of the capacity of this block becomes invalid data. Therefore, fragmentation occurs in this block, and it is necessary to execute garbage collection for this block. In the garbage collection for this block, it is necessary to read out about half of the capacity of this block as valid data and write the read valid data to another block. Therefore, in order to make this block a free block, a large amount of data needs to be written, which reduces the efficiency of garbage collection and results in a large write amplification.

In the first embodiment, the original data and mirror data are written to different blocks, and therefore even if only the mirror data is invalidated, no fragmentation occurs in the blocks where this mirror data is stored. Therefore, the frequency at which garbage collection is executed can be reduced, thereby making it possible to reduce write amplification.

### Second Embodiment

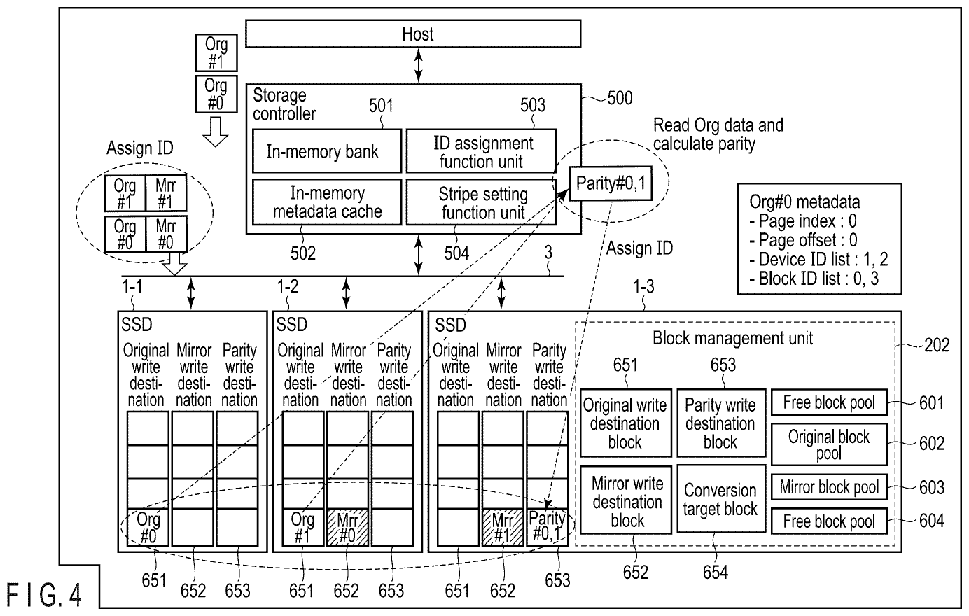

Next, the second embodiment will be explained. FIG. 4 is a block diagram illustrating an example of the configuration of an information processing system according to the second embodiment.

In the second embodiment, the storage controller 500 executes RAID level conversion processing. The storage controller 500 includes an in-memory bank 501, an in-memory metadata cache 502, an identifier assignment function unit 503, and further a stripe setting function unit 504.

The stripe setting function unit 504 executes processing to create a stripe group that includes two or more original data and one or more parity information. In the RAID level conversion processing, the storage controller 500 executes the following processing using the stripe setting function unit 504.

That is, when executing the RAID level conversion process, the storage controller 500 first determines three or more SSDs 1 that form the stripe group. For example, in the case where the SSD array contains M (>3) SSDs, the storage controller 500 determines three or more SSDs 1 that form the stripe group from M (>3) SSDs. The three or more SSDs 1 that form the stripe group mean the SSDs required to create the stripe group. In the following descriptions, it is assumed that a stripe group is created using three SSDs 1.

The storage controller 500 requests that the first SSD (for example, SSD 1-1) of the three SSDs 1 that have been determined to reserve one block in which the original data has already been written as a block to be subjected to RAID level conversion processing (hereinafter referred to as a “conversion target block”). The one block with the original data has already been written is one of the original blocks managed in the original block pool 602 of the SSD 1-1.

The storage controller 500 requests that the second SSD (for example, SSD 1-2) of the three SSDs that have been determined to reserve one block in which the original data has already been written as a conversion target block. The one block in which the original data has already been written is one of the original blocks managed in the original block pool 602 of the SSD 1-2.

The storage controller 500 requests that the third SSD (for example, SSD 1-3) of the three SSDs 1 that have been determined to reserve one free block as a parity write destination block 653. One free block is one of the free blocks managed in the free block pool 601 of the SSD 1-3. Further, the parity destination block 653 is the block to which the parity information should be written.

The storage controller 500 acquires the identifier (block ID) of the reserved block from each of the SSD 1-1, SSD 1-2, and SSD 1-3.

Specifically, the memory controller 11 of the SSD 1-1 reserves one original block as the conversion target block, and returns to the storage controller 500 a list of multiple logical addresses (hereinafter referred to as the logical address list) corresponding to the multiple original data stored respectively in multiple storage locations from the starting of the reserved original block to the end of the storage location, and the block ID of the reserved original block. The memory controller 11 of the SSD 1-1 can obtain the logical address list from the P2L table 302 of the SSD 1-1 by referring to the P2L table 302 of the SSD 1-1.

Similarly, the memory controller 11 of the SSD 1-2 reserves one original block as a conversion target block, and returns to the storage controller 500 a logical address list corresponding to the multiple original data stored in multiple storage locations from the storage location at the starting of the reserved original block to the storage location at the end of the reserved original block, and the block ID of the reserved original block.

The memory controller 11 of the SSD 1-3 reserves one free block as the parity write destination block 653, and returns the block ID of the reserved free block to the storage controller 500.

The storage controller 500 reads the first original data stored in the original block reserved by the SSD 1-1 from this original block reserved by the SSD 1-1. For example, if the original block reserved by the SSD 1-1 is the block used for writing the original data Org #0, then the original data Org #0 is read as the first original data.

Specifically, the storage controller 500 sequentially reads out the multiple original data stored respectively in the multiple storage locations from the storage location at the starting of the original block reserved by the SSD 1-1 to the storage location at the end. In this case, the storage controller 500 may send multiple read requests to the SSD 1-1, each of which specifies a logical address to be read, based on the logical address list acquired from the SSD 1-1. Alternatively, the storage controller 500 may send multiple read requests to the SSD 1-1, each specifying a block ID and a page index to be read. In the case where the original data Org #0 is stored at the starting of the storage locations of the original block reserved by the SSD 1-1, the original data Org #0 is first read from this reserved original block.

Next, the storage controller 500 reads the second original data stored in the original block reserved by the SSD 1-2 from this original block reserved by the SSD 1-2. For example, if the original block reserved by the SSD 1-2 is the block used to write the original data Org #1, then the original data Org #1 is read as the second original data.

Specifically, the storage controller 500 sequentially reads out the multiple original data stored in the multiple storage locations from the storage location at the starting of the original block reserved by the SSD 1-2 to the storage location at the end. In this case, the storage controller 500 may send multiple read requests to the SSD 1-2, each of which specifies a logical address to be read, based on the logical address list acquired from the SSD 1-2. Alternatively, the storage controller 500 may send multiple read requests to the SSD 1-2, each of which specifies a block ID and a page index to be read. In the case where the original data Org #1 is stored at the storage location at the starting of the original block reserved by the SSD 1-2, the original data Org #1 is first read from this reserved original block.

Next, the storage controller 500 calculates the first parity information using the first original data and the second original data. In the case where the first original data is the original data Org #0 and the second original data is the original data Org #1, the storage controller 500 calculates the first parity information (Parity #0, 1) using the original data Org #0 and the original data Org #1. The parity #0, 1 is obtained by calculating the exclusive logical sum of the original data Org #0 and the original data Org #1.

Next, the storage controller 500 generates a write request that requests the writing of the first parity information (Parity #0, 1). The identifier assignment function unit 503 of the storage controller 500 has a function of assigning an identifier indicating that the data to be written is parity information to each write request that requests the writing of parity information. The storage controller 500 assigns an identifier (third identifier) indicating that the data to be written is parity information to the generated write request, and transmits the write request including the third identifier to the SSD 1-3.

The memory controller 11 of the SSD 1-3 determines whether the identifier included in the write request received from the storage controller 500 is the first identifier, the second identifier, or the third identifier.

In the case where the identifier contained in the write request received from the storage controller 500 is the third identifier, the memory controller 11 of the SSD 1-3 writes the first parity information (Parity #0, 1) to the parity write destination block 653 of the SSD 1-3. The writing of data to the parity write destination block 653 is performed sequentially from the starting one of the storage locations, as in the case of the writing of data to each of the other blocks. For this reason, the first parity information (Parity #0, 1) is written to the starting storage location of the parity write destination block 653.

Therefore, the original data Org #0 stored in the starting storage location of the original block of the SSD 1-1, the original data Org #1 stored in the starting storage location of the original block of the SSD 1-2, and the first parity information (Parity #0, 1) stored in the starting storage location of the parity write destination block 653 of the SSD 1-3 belong to the same single stripe group. Therefore, the storage locations within the blocks where the original data Org #1 and the first parity information (Parity #0, 1) are respectively stored are the same as the storage locations within the block where the original data Org #0 is stored. The storage location at the starting of each block is expressed by page index=0 and page offset=0. The storage location (page index=0, page offset=0) within the block where the original data Org #0 is stored is the logical-physical address conversion information for the original data Org #0. Therefore, the storage locations within the blocks where the original data Org #1 and the first parity information (Parity #0, 1) are stored can be expressed by the logical-physical address conversion information for the original data Org #0 as well.

After completion of the writing of the first parity information (Parity #0, 1) to the parity write destination block 653 of the SSD 1-3, the storage controller 500 updates the metadata of the original data Org #0. Further, the storage controller 500 updates the metadata of the original data Org #1 as well.

In the process of updating the metadata of the original data Org #0, the storage controller 500 updates the metadata of the original data Org #0 by adding stripe group information and logical-physical address conversion information of the original data Org #0 to the metadata of the original data Org #0.

Here, the stripe group information includes a list of identifiers (device ID list) for three or more SSDs that form the stripe group and a list of identifiers (block ID list) for blocks that have been reserved on these three or more SSDs.

In the second embodiment, the stripe group is configured using the SSD 1-1, SSD 1-2, and SSD 1-3. Therefore, the device ID list basically includes 0, 1, and 2. Here, 0 represents the device ID of the SSD 1-1, 1 represents the device ID of the SSD 1-2, and 2 represents the device ID of the SSD 1-3.

Note that the metadata of the original data Org #0 is used as information to identify other original data and parity information that should be used to restore the original data Org #0. For this reason, the device ID list in the metadata of the original data Org #0 does not have to include the device ID of the SSD 1-1.

Further, the stripe group is formed by using the original blocks reserved in the SSD 1-1, the original blocks reserved in the SSD 1-2, and the parity write destination blocks in the SSD 1-3. For example, in the case where the block ID of the original block reserved in the SSD 1-1 is 0, the block ID of the original block reserved in the SSD 1-2 is 0, and the block ID of the parity write destination block reserved in the SSD 1-3 is 3, the block ID list is basically 0, 0, 3.

As in the case of the device ID list, the block ID list does not have to include the block ID of the original block that is reserved in the SSD 1-1.

The logical-physical address conversion information for the original data Org #0 is information that indicates the storage location within the block where the original data Org #0 is stored. Since the original data Org #0 is stored at the starting storage location within the block, the logical-physical address conversion information for the original data Org #0 is expressed by page index 0 and page offset 0. The storage location of each of the original data Org #1 and the parity data Parity #0, 1 within the block as well is the same as the storage location of the original data Org #0, that is, the starting storage location in the block. Therefore, page index 0 and page offset 0 are used as information common to the original data Org #0, the original data Org #1, and the parity data Parity #0, 1.

The metadata of the original data Org #1 is updated as in the case of updating of the metadata of the original data Org #0.

When the writing of the parity data Parity #0, 1 is completed, the mirror data Mrr #0 corresponding to the original data Org #0 and the mirror data Mrr #1 corresponding to the original data Org #1 become unnecessary.

Therefore, the storage controller 500 sends an invalidation request (trim request) specifying the logical address corresponding to the original data Org #0 to the SSD 1-2, where the mirror data Mrr #0 corresponding to the original data Org #0 is stored. The metadata of the original data Org #0 includes the device ID of the SSD 1-2, where the mirror data Mrr #0 is stored. Therefore, the storage controller 500 can identify the SSD (here, SSD 1-2) in which the mirror data Mrr #0 is stored by referring to the metadata of the original data Org #0. In this way, the mirror data Mrr #0 can be invalidated by sending a trim request which specifies the logical address corresponding to the original data Org #0 to the SSD 1-2.

The metadata of the original data Org #0 includes the device ID of the SSD 1-2, where the mirror data Mrr #0 is stored. Therefore, the storage controller 500 can identify the SSD (here, SSD 1-2) where the mirror data Mrr #0 is stored by referring to the metadata of the original data Org #0.

Further, the storage controller 500 sends an invalidation request (trim request) specifying the logical address corresponding to the original data Org #1 to the SSD 1-3, where the mirror data Mrr #1 corresponding to the original data Org #1 is stored. In this case, the metadata of the original data Org #1 includes the device ID of the SSD 1-3, where the mirror data Mrr #1 is stored. Therefore, the storage controller 500 can identify the SSD (here, SSD 1-3) in which the mirror data Mrr #1 is stored by referring to the metadata of the original data Org #1. In this way, the mirror data Mrr #1 can be invalidated by sending a trim request that specifies the logical address corresponding to the original data Org #1 to the SSD 1-3.

Thus, each of the mirror data is invalidated, and therefore the block used as the mirror write destination block 652 is more likely to have a larger number of program/erase cycles than that of the block used as the original write destination block 651.

Therefore, it is desirable that the memory controller 11 of each of the SSD 1-1 to 1-3 should allocate, as original destination blocks 651, those blocks of the multiple blocks of the NAND flash memory 13 which have a higher durability than a standard value for data rewriting.

Blocks with a higher durability for data rewriting than the standard value are, for example, single-level cell blocks (SLC blocks) in which one bit is written per memory cell, or blocks in which the number of program/erase cycles is less than a certain threshold value.

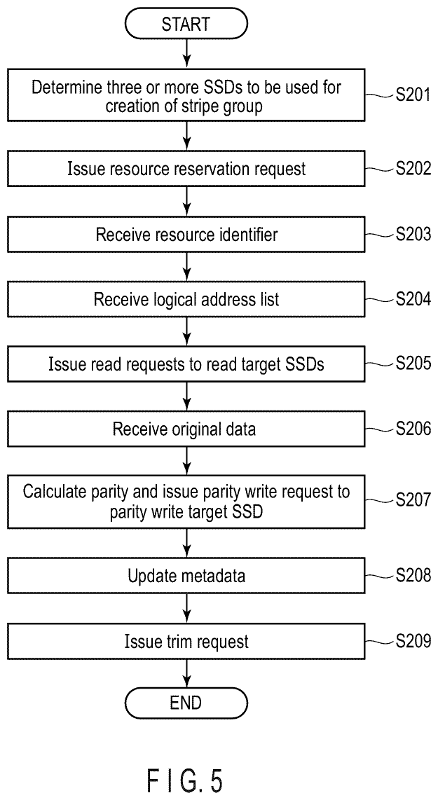

Next, the procedure of the RAID level conversion processing will be explained. FIG. 5 is a flowchart illustrating an example of the procedure of the RAID level conversion processing executed in the storage controller 500.

First, the storage controller 500 executes the RAID level conversion process based on the RAID setting information. The RAID setting information includes at least information indicating the number of SSDs that form the stripe group.

The storage controller 500 determines N SSDs 1 that form the stripe group (step S201). N is an integer greater than or equal to 3. Specifically, the storage controller 500 randomly determines N SSDs out of M (>N) SSDs included in the SSD array. Note that the storage controller 500 may as well randomly determine only one SSD as a starting point and determine (N−1) SSDs including the device ID of the determined one SSD and its consecutive device IDs. Alternatively, the storage controller 500 may determine N SSDs having a larger free capacity out of M (>N) SSDs. The storage controller 500 determines, among the N SSDs thus determined, one SSD to which the parity should be written and (N−1) SSDs that provide the original data. The SSD to which the parity should be written is also referred to a parity write target SSD. The SSDs that provide the original data are also referred to as read target SSDs.

The storage controller 500 issues a resource reservation request to each of the N SSDs that have been determined (step S202). The resource reservation request issued to the parity write target SSDs request the parity write target SSDs to reserve free blocks as parity write destination blocks. The resource reservation request issued to each of the (N−1) read target SSDs request that each read target SSD reserve an original block, which is a block to which the original data has already written.

The storage controller 500 receives the identifier (block ID) of the reserved block from each of the N SSDs (step S203). Then, the storage controller 500 receives the logical address list from each of the (N−1) read target SSDs (step S204). The storage controller 500 issues a read request to each of the (N−1) read target SSDs (step S205). In this way, the storage controller 500 receives (N−1) original data respectively from the (N−1) read target SSDs (step S206).

The storage controller 500 calculates the parity of the (N−1) original blocks read from the (N−1) read target SSDs, and issues a write request for the calculated parity to the write target SSD (step S207). This write request is given an identifier (third identifier) indicating that the parity is to be written. In this manner, the parity is written to the reserved parity destination block in the write target SSD.

Then, the storage controller 500 updates the metadata of each of the original data belonging to the same stripe group as that of the parity for which the writing has been completed (step S208).

After this, the storage controller 500 issues a trim request to invalidate the mirror data corresponding to each original data belonging to the same stripe group as that of the parity for which writing has been completed to the SSD where this mirror data is stored (step S209), and thus the RAID level conversion process is finished.

As described above, in the RAID level conversion process, the storage controller 500 reads out (N−1) original data respectively stored in (N−1) SSDs, calculates the parity of those (N−1) original data, and stores the calculated parity in another SSD. For example, in the case where the SSD 1-1 and SSD 1-2 are the read target SSDs, and SSD 1-3 is the write target SSD, the parity (Parity #0, 1) of the original data (for example, original data Org #0) read from the SSD 1-1 and the original data (for example, original data Org #1) read from the SSD 1-2 is calculated.

Note that the RAID level conversion process can be performed by executing a write operation for mirroring to the SSD array and thereafter additionally writing, for example, two data and one parity to the SSD array as data for erasure coding. In this case, the storage controller 500 first executes the writing of the original data Org #0 and mirror data Mrr #0. Next, the storage controller 500 executes the writing of the original data Org #1 and the mirror data Mrr #1. After the data in the in-memory bank 501 has reached the size corresponding to the stripe group, the storage controller 500 additionally writes these data (original data Org #0 and original data Org #1) and the parity calculated from these data (Parity #0 and Parity #1) to the SSD array. The total number of data written to the SSD array is 7 (mirroring: 4, erasure coding: 3). While the number of data requested to be written from the host 2 is 2, 7 data are written to the SSD array, and therefore the write amplification becomes 3.5.

In the second embodiment, on the other hand, the original data Org #0 and Org #1 written for mirroring are used as they are for erasure coding. Therefore, in the RAID level conversion process, only the parity Parity #0, 1 is written to the SSD array. Therefore, the total number of data written to the SSD array is 5 (mirroring: 4, erasure coding: 1). While the number of data requested to be written from the host 2 is 2, 5 data are written to the SSD array, and therefore the write amplification becomes 2.5. Therefore, compared to the case where, for example, two original data and one parity are additionally written to the SSD array as data for erasure coding, the write amplification can be reduced.

### Third Embodiment

Next, the third embodiment will be explained. In the third embodiment, SSD 1-1, SSD 1-2, and SSD 1-3 each have the function of the storage controller 500.

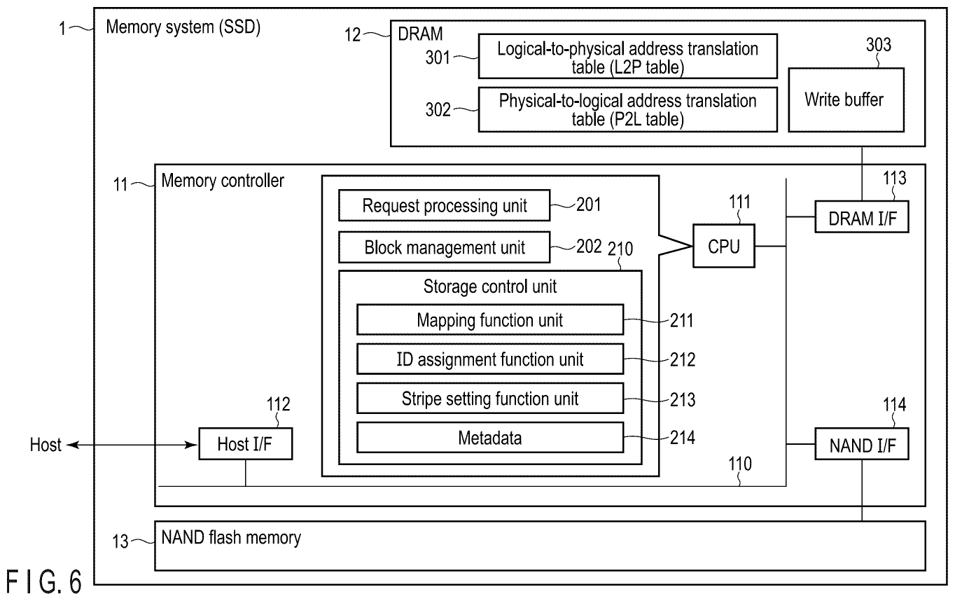

FIG. 6 is a block diagram illustrating an example of the configuration of the SSD 1 according to the third embodiment. The CPU 111 of the memory controller 11 includes a request processing unit 201, a block management unit 202, and, in addition, a storage control unit 210. The storage control unit 210 may be implemented by dedicated hardware within the memory controller 11, or it may be implemented by a separate LSI from the memory controller 11.

The storage control unit 210 executes the process of duplicating the write request that requests the writing of the original data and generating a write request that requests the writing of mirror data, and further the RAID level conversion processing and the like.

The storage control unit 210 includes a mapping function unit 211, an identifier assignment function unit 212, and a stripe setting function unit 213. The storage control unit 210 further manages the metadata 214 of each of the original data.

The mapping function 211 provides a function for uniquely determining the SSD with the highest priority and the SSD with the next highest priority from among the SSD 1-1 to SSD 1-3 in the SSD array based on the logical address input. The mapping function 211 outputs two device IDs uniquely determined from the logical address input in a ranking format in order of priority, for example, using a hash function. The mapping function 211 is used to determine the original destination SSD and the mirror write destination SSD from among the SSD 1-1 to SSD 1-3 in the SSD array. For example, the SSD with the highest priority, that is, the SSD with the first-ranked device ID, is determined as the original destination SSD, and the SSD with the next-highest priority, that is, the SSD with the second-ranked device ID, is determined as the mirror write destination SSD.

The identifier assignment function 212 assigns identifiers (first identifier, second identifier, and third identifier) indicating the type of data to be written (original data, mirror data, and parity information) to a write request transferred from the SSD 1 to another SSD 1 in the SSD array.

The stripe configuration function unit 504 executes a process for creating a stripe group that includes two or more original data and one or more parity information.

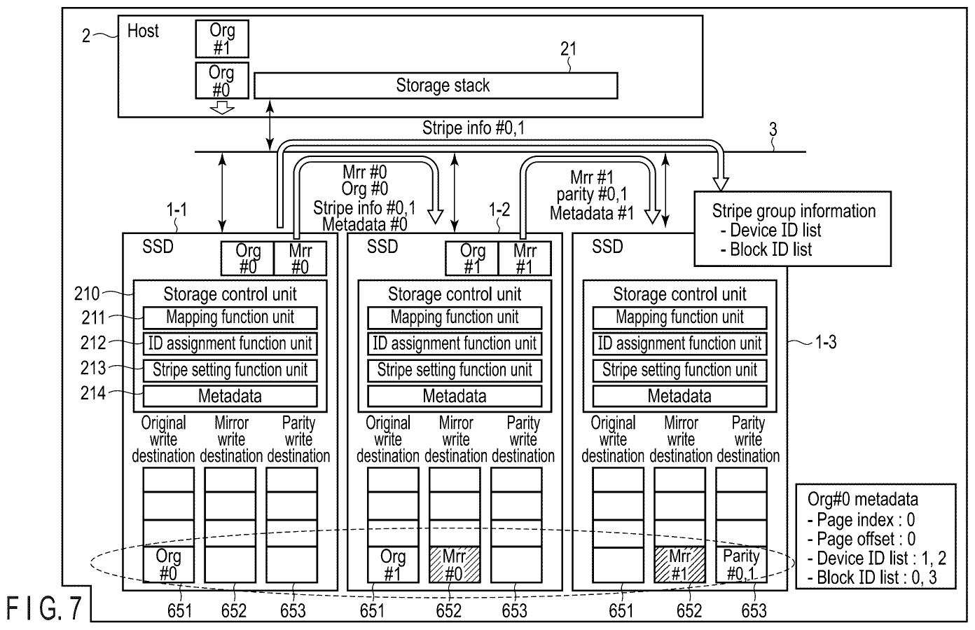

FIG. 7 is a block diagram illustrating an example of the configuration of an information processing system according to the third embodiment. In the first and second embodiments, SSD 1-1, SSD 1-2, and SSD 1-3 were each connected to the storage controller 500 via the communication path 3. By contrast, in the third embodiment, the functions of the storage controller 500 are offloaded to each of the SSD 1-1, SSD 1-2, and SSD 1-3, and the storage controller 500 is not provided. Each of the SSD 1-1, SSD 1-2, and SSD 1-3 is connectable to the host 2 and two or more other SSDs in the SSD array. In FIG. 7, each of SSD 1-1, SSD 1-2, and SSD 1-3 communicates with the host 2 via the communication path 3, and further communicates with each of the other SSD of the SSD 1-1, SSD 1-2, and SSD 1-3 via the communication path 3. When the communication path 3 is a PCIe bus, each of SSD 1-1, SSD 1-2, and SSD 1-3 performs communication with each of the other SSDs among the SSD 1-1, SSD 1-2, and SSD 1-3 via a PCIe switch.

### (Mirroring)

The host 2 issues only write requests for data (that is, the original data) to any SSD in the SSD array via the storage stack 21 of the host 2. The processing for writing the original data and mirror data to different SSDs is performed by the storage control unit 210 of each of the SSD 1-1, SSD 1-2, and SSD 1-3.

Here, it is assumed that the SSD 1-1 receives a first write request requesting the writing of the first data (original data) from the host 2.

Upon receiving the first write request for the first data (original data) from the host 2, the storage control unit 210 of the SSD 1-1 determines the original destination SSD to which the first data (original data) should be written, and the destination SSD to which the mirror data should be written, which is a duplicate of the first data (original data), from among SSD 1-1, SSD 1-2, and SSD 1-3, based on the logical address specified by the received first write request. In this case, the storage control unit 210 of the SSD 1-1 determines the original destination SSD to which the first data (original data) should be written and the destination SSD to which the mirror data, which is a duplicate of the first data (original data), should be written, using the mapping function unit 211.

Case 1: When the SSD 1-1 is determined as the original destination SSD, the storage control unit 210 of the SSD 1-1 writes the first data (original data) to the original write destination block 651 of the SSD 1-1. The storage control unit 210 of the SSD 1-1 then assigns the second identifier to indicate that the data to be written is mirror data to the first write request, and transfers the first write request including the second identifier to another SSD in the SSD array that has been determined as the mirror write destination SSD.

The first write request includes a data pointer indicating the location in the memory of the host 2 where the first data is stored. Therefore, the storage control unit 210 of the SSD 1-1 acquires the first data (original data) from the memory of the host 2 and writes the acquired first data (original data) to the original write destination block 651 of the SSD 1-1. Similarly, the first write request that has been transferred to another SSD also contains the same data pointer, and therefore the storage control unit 210 of the other SSD also acquires the first data (original data) from the memory of the host 2. Note here that the first write request transferred to the other SSD contains a second identifier. Therefore, the storage control unit 210 of the other SSD treats the first data (original data) thus acquired as mirror data, and writes the first data (original data) thus acquired as mirror data for the first data (original data) to the mirror write destination block 652 of this other SSD.

Case 2: When the SSD 1-1 is determined as mirror write destination SSD, the storage control unit 210 of the SSD 1-1 treats the first data as mirror data and writes the first data to the mirror writing destination block 652 of the SSD 1-1 as the mirror data for the first data. Then, the storage control unit 210 of the SSD 1-1 assigns the first identifier indicating that the data to be written is the original data to the first write request, and transfers the first write request including the first identifier to another SSD in the SSD array that has been determined as the original write destination SSD.

As described above, the storage control unit 210 of the SSD 1-1 can acquire the first data from the memory of the host 2. Similarly, the storage control unit 210 of the other SSD to which the first write request including the first identifier has been transferred can also acquire the first data from the memory of the host 2. Then, the storage control unit 210 of this other SSD writes the acquired first data to the original destination block of this other SSD.

Case 3: When it is determined that the SSD 1-1 is neither the original destination SSD nor the mirror write destination SSD, the storage control unit 210 of the SSD 1-1 assigns the first identifier to the first write request and transfers the first write request including the first identifier to the other SSD that has been determined as the original destination SSD. Further, the storage control unit 210 of the SSD 1-1 assigns the second identifier to the first write request and transfers the first write request including the second identifier, to still another SSD that has been determined as the mirror write destination SSD.

The storage control unit 210 of the other SSD to which the first write request including the first identifier has been transferred can acquire the first data from the memory of the host 2. Then, the storage control unit 210 of this other SSD writes the acquired first data to the original destination block of this other SSD.

The storage control unit 210 of the still other SSD to which the first write request including the second identifier has been transferred can acquire the first data from the memory of the host 2. Then, the storage control unit 210 of the still other SSD writes the acquired first data to the mirror destination block of the still other SSD as the mirror data of the first data.

Note that when a write request is received from the SSD 1-2 or SSD 1-3, the storage control unit 210 of the SSD 1-3 executes the following process.

That is, the storage control unit 210 of the SSD 1-1 determines whether the identifier contained in the received write request is the first identifier or the second identifier. In the case where the identifier contained in the received write request is the first identifier, the storage control unit 210 of the SSD 1-1 writes the data associated with the received write request to the original write destination block 651 of the SSD 1-1. In the case where the identifier contained in the received write request is the second identifier, the storage control unit 210 of the SSD 1-1 writes the data associated with the received write request to the mirror write destination block 652 of the SSD 1-1.

FIG. 7 shows an example of the case where the SSD 1-1 receives a write request for the original data Org #0 (hereinafter, referred to as “write request A”) from the host 2, and the SSD 1-2 receives a write request for the original data Org #1 (hereinafter referred to as “write request B”) from the host 2.

First, the operation in the SSD 1-1 will be explained.

The storage control unit 210 of the SSD 1-1 determines the SSD 1-1 as the original destination SSD and the SSD 1-2 as the mirror write destination SSD based on the logical address specified by the write request A using the mapping function unit 211.

The storage control unit 210 of the SSD 1-1 writes the data associated with the write request A (original data Org #0) to the original write destination block 651 within the SSD 1-1. The storage control unit 210 of the SSD 1-1 assigns the second identifier indicating that mirror data should be written to the write request A. The write request A including the second identifier is transferred to the SSD 1-2 as a write request for the mirror data Mrr #0, which is a duplicate of the original data Org #0.

Next, the operation in the SSD 1-2 will be explained.

The storage control unit 210 of the SSD 1-2 receives a write request A including a second identifier from the SSD 1-1 as a write request for mirror data Mrr #0. The storage control unit 210 of the SSD 1-2 writes the original data Org #0 as mirror data Mrr #0 to the mirror write destination block 652.

Further, the storage control unit 210 of the SSD 1-2 determines the SSD 1-2 as the original write destination SSD and the SSD 1-3 as the mirror write destination SSD based on the logical address specified by the write request B.

The storage control unit 210 of the SSD 1-2 writes the data associated with the write request B (original data Org #1) to the original write destination block 651 in the SSD 1-2. The storage control unit 210 of the SSD 1-2 assigns a second identifier indicating that mirror data should be written to the write request B. The write request B including the second identifier is transferred to the SSD 1-3 as a write request for the mirror data Mrr #1.

Next, the operation in the SSD 1-3 will be explained.

The storage control unit 210 of the SSD 1-2 receives the write request B including the second identifier, from the SSD 1-2 as a write request for the mirror data Mrr #1. The storage control unit 210 of the SSD 1-3 writes the original data Org #1 as the mirror data Mrr #1 to the mirror write destination block 652.

As a result of the above-described operations, in response to the write request A from the host 2, the original data Org #0 is written to the original write destination block 651 in the SSD 1-1, and the mirror data Mrr #0 is written to the mirror write destination block 652 in the SSD 1-2. Further, in response to the write request B from the host 2, the original data Org #1 is written to the original write destination block 651 in the SSD 1-2, and the mirror data Mrr #1 is written to the mirror write destination block 652 in the SSD 1-3.

### (RAID Level Conversion Processing)

The storage control unit 210 of the SSD 1-1, the storage control unit 210 of the SSD 1-2, and the storage control unit 210 of the SSD 1-3 each have a RAID level conversion function that executes RAID level conversion processing. When the RAID level conversion function of a storage control unit 210 is activated, the SSD including this storage control unit 210 operates as a device (parent device) that starts the RAID level conversion processing. Each of the other SSDs operates as a child device.

When the SSD 1-1 operates as the device (parent device) that starts the RAID level conversion processing, the storage control unit 210 of the SSD 1-1 executes the following processing.

The storage control unit 210 of the SSD 1-1 first determines three or more SSDs that form the stripe group. For example, in the case where the SSD array contains M (>3) SSDs, the storage control unit 210 of the SSD 1-1 determines three or more SSDs 1 from among M (>3) SSDs which form a stripe group. In the following descriptions, it is assumed that a stripe group is created using three SSDs 1.

A stripe group includes two read target SSDs that provide the original data and one parity write target SSD that is used as the parity write destination. The SSD 1-1, which is the parent device, is included in the three SSDs as the first SSD, which is one of the two read target SSDs.

In the example shown in FIG. 7, a stripe group is created using the SSD 1-1, SSD 1-2, and SSD 1-3.

The storage control unit 210 of the SSD 1-1 reserves one block in the SSD 1-1, to which the original data has already been written as a target block to be subjected to the RAID level conversion processing (conversion target block).

The storage control unit 210 of the SSD 1-1 requests that the second SSD (for example, SSD 1-2) of the three SSDs that have been determined, to reserve one block to which the original data has already been written, as a conversion target block.

The storage control unit 210 of the SSD 1-1 requests the third SSD (for example, SSD 1-3) of the three SSDs that have been determined, to reserve one free block as a parity write destination block 653.

The stripe configuration function 213 acquires the identifier (block ID) of the reserved block from each of the SSD 1-1, SSD 1-2, and SSD 1-3.

Then, the storage control unit 210 of the SSD 1-1 generates stripe group information and transmits the stripe group information to the SSD 1-2 and SSD 1-3, thereby sharing the generated stripe group information with the SSD 1-2 and SSD 1-3. The stripe group information includes, for example, a list of the identifiers of the three or more SSDs that form the stripe group (device ID list) and a list of the identifiers of the blocks that have been reserved in these three or more SSDs (block ID list). The stripe group information is used to update or generate the metadata described below.

Then, the storage control unit 210 of the SSD 1-1 reads the first original data stored in the original block reserved in the SSD 1-1 from this original block reserved in the SSD 1-1. For example, if the original block reserved in the SSD 1-1 is the block used for writing the original data Org #0, then the original data Org #0 is read as the first original data.

Specifically, the storage control unit 210 of the SSD 1-1 sequentially reads out multiple original data stored respectively in the multiple storage locations from the storage location at the starting of the original block reserved in the SSD 1-1 to the storage location at the end of the original block. In the case where the original data Org #0 is stored in the starting storage location of the reserved original block in the SSD 1-1, then the original data Org #0 is read first from this reserved original block. The storage control unit 210 of the SSD 1-1 transmits the read original data Org #0 to the SSD 1-1 for calculating the parity information.

Next, the operation in the SSD 1-2 will be explained.

The storage control unit 210 of the SSD 1-2 receives the original data Org #0 from the SSD 1-1. The storage control unit 210 of the SSD 1-2 reads the second original data stored in the original block reserved by the SSD 1-2 from this original block reserved by the SSD 1-2. For example, if the original block reserved by the SSD 1-2 is the block used to write the original data Org #1, then the original data Org #1 is read out as the second original data.

Specifically, the storage control unit 210 of the SSD 1-2 sequentially reads out the multiple original data stored in the multiple storage locations from the storage location at the starting of the original block reserved in the SSD 1-2 to the storage location at the end of the original block. If the original data Org #1 is stored in the storage location at the starting of the original block reserved in the SSD 1-2, the original data Org #1 is first read out from this reserved original block.

Next, the storage control unit 210 of the SSD 1-2 calculates the first parity information using the first original data and the second original data. In the case where the first original data is the original data Org #0 and the second original data is the original data Org #1, the storage control unit 210 of the SSD 1-2 calculates the first parity information (Parity #0, 1) using the original data Org #0 and the original data Org #1. The parity Parity #0, 1 is obtained by calculating the exclusive OR of the original data Org #0 and the original data Org #1.

Next, the storage control unit 210 of the SSD 1-2 generates a write request that requests the writing of the first parity information (Parity #0, 1). The storage control unit 210 of the SSD 1-2 has a function that assigns a third identifier indicating that the data to be written is parity information to each of the write requests that request the writing of parity information. The storage control unit 210 of the SSD 1-2 assigns a third identifier indicating that the data to be written is parity information to the write request thus generated, and transmits the write request including the third identifier to the SSD 1-3.

Next, the operation in the SSD 1-3 will be explained.

The storage control unit 210 of the SSD 1-3 determines whether the identifier contained in the write request received from the SSD 1-2 is the first identifier, the second identifier, or the third identifier.

In the case where the identifier contained in the write request received from the SSD 1-2 is the third identifier, the storage control unit 210 of the SSD 1-3 writes the first parity information (Parity #0, 1) to the parity write destination block 653 of the SSD 1-3. The writing of data to the parity write destination block 653 is performed sequentially from the starting one of the storage locations, as in the case of the writing of data to each of the other blocks. For this reason, the first parity information (Parity #0, 1) is written to the starting one of the storage locations of the parity write destination block 653.

Therefore, the original data Org #0 stored in the starting storage location of the original block of the SSD 1-1, the original data Org #1 stored in the starting storage location of the original block of the SSD 1-2, and the first parity information (Parity #0, 1) stored in the starting storage location of the parity write destination block 653 of the SSD 1-3 belong to the same stripe group. Therefore, the storage locations within the blocks where the original data Org #1 and the first parity information (Parity #0, 1) are stored are the same as the storage locations within the block where the original data Org #0 is stored. The storage location at the starting of each block is expressed by page index=0 and page offset=0. The storage location (page index=0, page offset=0) within the block where the original data Org #0 is stored is the logical-physical address conversion information for the original data Org #0. Therefore, the storage location within the block where the original data Org #1 and the first parity information (Parity #0, 1) are stored as well can be expressed by the logical-physical address conversion information for the original data Org #0.

After completion of the writing of the first parity information (Parity #0, 1) to the parity write destination block 653 of the SSD 1-3, the storage control unit 210 of the SSD 1-3 notifies the SSD 1-2 that the writing of the first parity information (Parity #0, 1) is completed.

The storage control unit 210 of the SSD 1-2 generates metadata for the original data Org #1, which belongs to the same stripe group as that of the parity information (Parity #0, 1), in response to the notification from the SSD 1-3 that the writing of the first parity information (Parity #0, 1) is completed. In the process of generating the metadata for the original data Org #1, the storage control unit 210 of the SSD 1-2 generates the metadata for the original data Org #1, which includes the stripe group information received from the SSD 1-1 and the logical-physical address conversion information for the original data Org #1. Then, the storage control unit 210 of the SSD 1-2 identifies the SSD (here, SSD 1-3) that stores the metadata Mrr #corresponding to the original data Org #1. In this case, the logical address of the original data Org #1 may first be obtained by referring to the P2L table 302. Then, by inputting the logical address of the original data Org #1 into the mapping function 211, the SSD (here, SSD 1-3) that stores the metadata Mrr #corresponding to the original data Org #1 may be identified. Then, the storage control unit 210 of the SSD 1-2 sends the generated metadata to the identified SSD (here, SSD 1-3) so that the identified SSD (here, SSD 1-3) retains the generated metadata.

Further, the storage control unit 210 of the SSD 1-2 notifies the SSD 1-1 that the writing of the first parity information (Parity #0, 1) is completed.

Here, the stripe group information used to generate the metadata for the original data Org #1 includes a list of the identifiers of the three or more SSDs that form the stripe group (device ID list) and a list of the identifiers of the blocks reserved in these three or more SSDs (block ID list).

In the third embodiment, the stripe group is configured using the SSD 1-1, SSD 1-2, and SSD 1-3. Therefore, basically, the device ID list includes 0, 1, and 2. Here, 0 represents the device ID of the SSD 1-1, 1 represents the device ID of the SSD 1-2, and 2 represents the device ID of the SSD 1-3.

Note that the metadata of the original data Org #1 is used as information to identify other original data and parity information that should be used to restore the original data Org #1. For this reason, the device ID list in the metadata of the original data Org #1 need not include the device ID of the SSD 1-2.

Further, the stripe group is formed by the original blocks reserved in the SSD 1-1, the original blocks reserved in the SSD 1-2, and the parity write destination blocks reserved in the SSD 1-3. For example, if the block ID of the original block reserved in the SSD 1-1 is 0, the block ID of the original block reserved in the SSD 1-2 is 0, and the block ID of the parity write destination block reserved in the SSD 1-3 is 3, the block ID list basically includes 0, 0, and 3.

As in the case of the device ID list, the block ID list as well need not include the block ID of the original block that is reserved in the SSD 1-2.

The logical-physical address conversion information for the original data Org #1 is information that indicates the location within the block, where the original data Org #1 is stored. Since the original data Org #1 is stored at the starting storage location within the block, the logical-physical address conversion information for the original data Org #1 is expressed by page index 0 and page offset 0. The storage locations within the block for the original data Org #0 and the parity data Parity #0, 1 are also the same as for the original data Org #1, that is the starting storage location within the block. Therefore, page index 0 and page offset 0 are used as information common to the original data Org #0, the original data Org #1, and the parity data Parity #0, 1.

Further, when the writing of the parity data Parity #0, 1 is completed, the mirror data Mrr #1 corresponding to the original data Org #1 becomes unnecessary.

Therefore, the storage control unit 210 of the SSD 1-2 sends an invalidation request (trim request) that specifies the logical address corresponding to the original data Org #1 to the SSD 1-3, where the mirror data Mrr #1 corresponding to the original data Org #1 is stored.

Further, the storage control unit 210 of the SSD 1-1 generates the metadata for the original data Org #0 as in the case of the generation of the metadata for the original data Org #1 in response to the notification by the SSD 1-2 that the writing of the first parity information (Parity #0, 1) is completed.

Further, when the writing of Parity #0, 1 is completed, the mirror data Mrr #0 corresponding to the original data Org #0 becomes unnecessary. The stripe setting function unit 213 of the SSD 1-1 invalidates the mirror data Mrr #0 as in the case of the invalidation of the mirror data Mrr #1.

As described, each mirror data is invalidated, and therefore the block used as the mirror write destination block 652 is more likely to have a larger number of program/erase cycles than that of the block used as the original write destination block 651.

Therefore, it is desirable that the memory controller 11 of each of the SSDs 1-1 to 1-3 should select, as the original write destination block 651, blocks that have a higher durability than the standard value for data rewriting, among the multiple blocks of the NAND flash memory 13.

The blocks having a higher durability than the standard value for data rewriting are, for example, single-level cell blocks (SLC blocks) in which one bit is written per memory cell, or blocks in which the number of program/erase cycles is less than a certain threshold value.

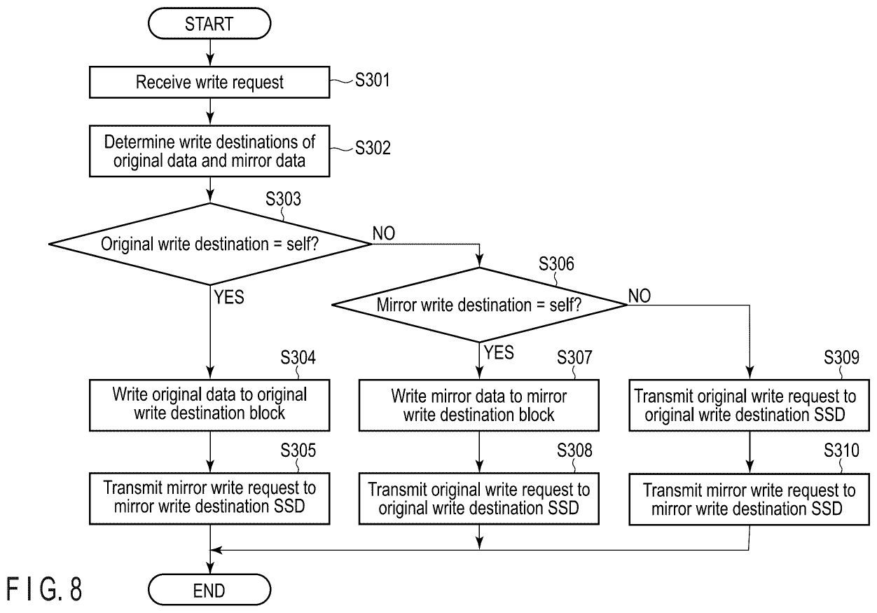

FIG. 8 is a flowchart illustrating an example of the procedure for the write control processing executed in the SSD 1. The write control process is a process for controlling the writing of original data and mirror data based on the write request received from the host 2. In the following descriptions, the write control process executed in the SSD 1-1 will be explained as an example.

First, the storage control unit 210 of the SSD 1-1 receives a write request from the host 2 via the host I/F 112 (step S301). The storage control unit 210 determines the SSD 1 (original destination SSD 1) to which the original data is written and the SSD 1 (mirror write destination SSD 1) to which the mirror data is written based on the logical address specified by the received write request (step S302).

The storage control unit 210 determines whether the original destination SSD 1 thus determined is the SSD 1-1 (that is, itself) (step S303).

In the case where the original destination SSD 1 is the SSD 1-1 (YES in step 303), the storage control unit 210 writes the data (that is, original data) associated with the received write request to the original destination block (step 304). Then, the storage control unit 210 assigns a second identifier to the received write request, and transmits the write request including the second identifier to the mirror write destination SSD 1 as a mirror write request (step S305). Thus, the write control process is finished.

In the case where the original write destination SSD 1 is not the SSD 1-1 (NO in step 303), the storage control unit 210 determines whether or not the mirror write destination SSD 1 is the SSD 1-1 (step 306).

In the case where the mirror write destination SSD 1 is the SSD 1-1 (YES in step 306), the storage control unit 210 writes the data associated with the received write request to the mirror destination block (step 307). Then, the storage control unit 210 assigns a first identifier to the received write request, and transmits the write request including the first identifier to the original write destination SSD 1 as the original write request (step S308). Thus, the write control process is finished.

In the case where the mirror write destination SSD 1 is not the SSD 1-1 (NO in step 306), that is, the SSD 1-1 is neither the original destination SSD 1 nor the mirror write destination SSD 1, the storage control unit 210 assigns a first identifier to the received write request, and transmits the write request including the first identifier to the original write destination SSD 1 as an original write request (step S309). As a result, the data associated with this write request is written to the original write destination block in the original write destination SSD 1. Further, the storage control unit 210 assigns a second identifier to the received write request, and transmits the write request including the second identifier to the mirror write destination SSD 1 as a mirror write request (step S310). Thus, the data associated with this write request is written to the mirror destination block in the mirror write destination SSD 1. Then the storage control unit 210 finishes the write control process.

With the above-described write control processing, depending on whether the original destination SSD 1 is the SSD 1-1, the mirror write destination SSD 1 is the SSD 1-1, or neither the original destination SSD 1 or mirror write destination SSD 1 is the SSD 1-1, the SSD 1-1 can control the writing of original data and mirror data in the multiple SSDs 1.

### (RAID Level Conversion)

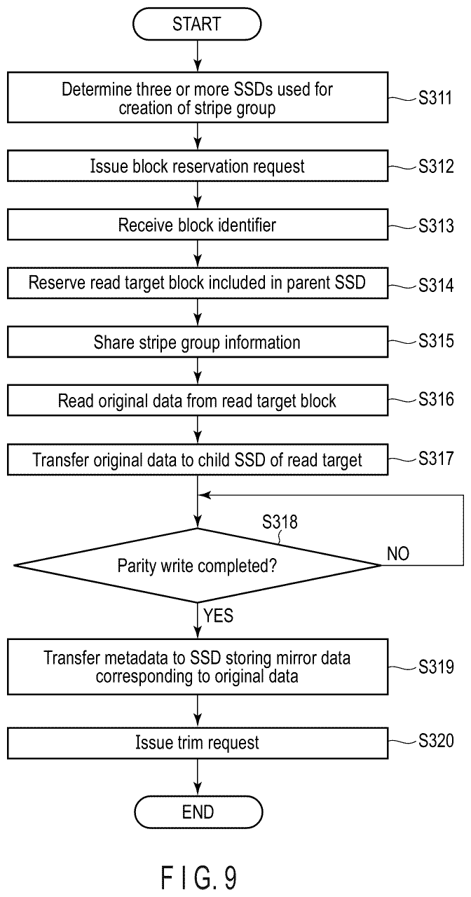

FIG. 9 is a flowchart illustrating an example of the procedure for the first RAID level conversion process executed in the SSD 1. The first RAID level conversion process is a process executed in the parent SSD 1.

First, the storage control unit 210 of the parent SSD 1 determines N (N is an integer greater than or equal to 3) SSDs 1 that form the stripe group (step S311). In the N SSDs 1, the parent SSD 1 is included as a read target SSD.

The storage control unit 210 issues a block reservation request (resource reservation request) to each of the (N−1) SSDs obtained by excluding the parent SSD 1 from the N SSDs (step S312). Each of the (N−1) SSDs 1 is also referred to as a child SSD 1. The (N−1) child SSDs 1 include one child SSD 1 of the parity write target and (N−2) child SSDs 1 of the read target. The resource reservation request issued to the child SSD 1 of the parity write target is a request to reserve the write destination block. The resource reservation requests issued respectively to the (N−2) child SSDs of the read target are requests to reserve the read target blocks. The storage control unit 210 receives the identifiers of the reserved blocks from the (N−1) child SSDs, respectively (step S313).

The storage control unit 210 reserves the read target block in the parent SSD 1 (step S314). The storage control unit 210 transmits the stripe group information to each of the other SSDs to share the stripe group information (step S315). The storage control unit 210 reads the original data from the read target block that has been reserved (step S316). The storage control unit 210 transfers the read original data to the child SSD 1 of the read target (step S317). The child SSD 1 of the read target is one of the (N−2) child SSDs 1 of the read target.

Next, the storage control unit 210 determines whether or not it has been notified that the writing of the parity was completed by the child SSD 1 of the read target, to which the original data is to be transferred (step S318). In the case where it has not yet been notified that the writing of the parity was completed (NO in step S318), the storage control unit 210 returns its operation to step S318. That is, the storage control unit 210 stands by until it is notified that the writing of the parity has been completed.

When it is notified that the writing of the parity has been completed (YES in step S318), the storage control unit 210 updates or generates metadata for the original data included in the same stripe group as that of this parity, and transfers the updated or generated metadata to the child SSD that stores the mirror data corresponding to this original data (step S319).

Next, the storage control unit 210 issues a trim request to invalidate this mirror data to the child SSD that stores this mirror data (step S320), and finishes the first RAID level conversion process. In this manner, the mirror data is invalidated in the child SSD storing the mirror data.

As a result of the above-described first RAID level conversion process, the parent SSD 1 determines the N SSDs that form the stripe group, and sends the original data stored in the reserved read target blocks to the child SSD 1 of the read target. Thus, the child SSD 1 of the read target can generate intermediate parity or parity using the original data received from the parent SSD 1 and the original data stored in the child SSD 1 of the read target. Further, upon completion of the writing of the parity, the parent SSD 1 issues a trim request to invalidate the mirror data corresponding to the original data. Therefore, the parent SSD 1 can convert the RAID level from RAID1 to RAID5 in cooperation with (N−1) child SSDs 1.

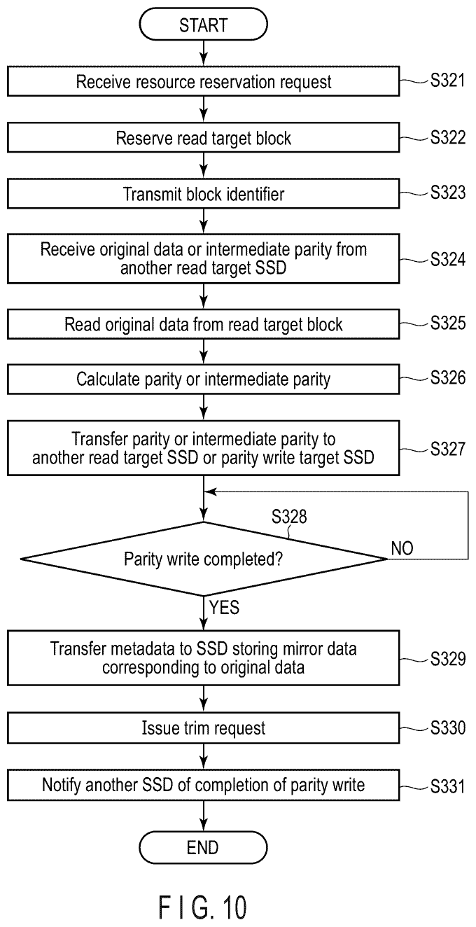

FIG. 10 is a flowchart illustrating an example of the procedure for the second RAID level conversion process executed in the SSD 1. The second RAID level conversion process is a process performed in the child SSD 1 of the read target, among the RAID conversion processes. The child SSD 1 of the read target is an SSD 1 that: (1) receives either the original data or the intermediate parity from another SSD 1 of the read target, and (2) then either transmits the intermediate parity to still another SSD 1 of the read target, or transmits the parity to the SSD 1 of the parity write target.

First, the storage control unit 210 of the child SSD 1 of the read target receives a resource reservation request from the parent SSD 1 (step S321). The storage control unit 210 reserves a read target block in response to the resource reservation request thus received (step S322). The storage control unit 210 sends the identifier of the reserved read target block to the parent SSD 1 (step S323).

Next, the storage control unit 210 receives the original data or intermediate parity from another read target SSD 1 (hereinafter also referred to as a reception source SSD 1) (step S324). Specifically, in the case where the reception source SSD 1 is the parent SSD 1, the storage control unit 210 receives the original data from the parent SSD 1. Further, in the case where the reception source SSD 1 is the child SSD 1 of the read target, the storage control unit 210 receives the intermediate parity from the child SSD 1 of the read target.

Further, the storage control unit 210 reads the original data from the reserved read target block (step S325). The storage control unit 210 calculates the parity or intermediate parity using the read original data and the received original data or intermediate parity (step S326). The storage control unit 210 transfers the intermediate parity to another child SSD 1 of the read target or transfers the parity to the parity write target SSD 1 (step S327). The SSD 1 to which the intermediate parity or the parity is to be transferred is also referred to as a transfer destination SSD 1.

Next, the storage control unit 210 determines whether or not it has been notified by the transfer destination SSD 1 that the writing of the parity has been completed (step S328). If it has not yet been notified that the writing of the parity was completed (NO in step S328), the storage control unit 210 returns its operation to step S328. That is, the storage control unit 210 stands by until it is notified that the writing of the parity has been completed.

When it is notified that the writing of the parity has been completed (YES in step S328), the storage control unit 210 updates or generates the metadata of the original data included in the same stripe group as that of this parity, and transfers the updated or generated metadata to the child SSD (mirror storage destination SSD 1) that stores the mirror data corresponding to this original data (step S329).

Next, the storage control unit 210 issues a trim request to invalidate the mirror data to the mirror storage destination SSD 1 (step S330). The storage control unit 210 then notifies the reception source SSD that the writing of the parity has been completed (step S331), and thus the second RAID level conversion process is finished.

In the above-described second RAID level conversion process, the child SSD 1 of the read target receives the original data or intermediate parity from another SSD 1 of the read target, and generates the intermediate parity or parity using the received original data or intermediate parity and the original data stored in itself. Then, the child SSD 1 of the read target performs either the transfer of the generated intermediate parity to another child SSD 1 of the read target, or the transfer of the generated parity to the parity write target SSD 1.

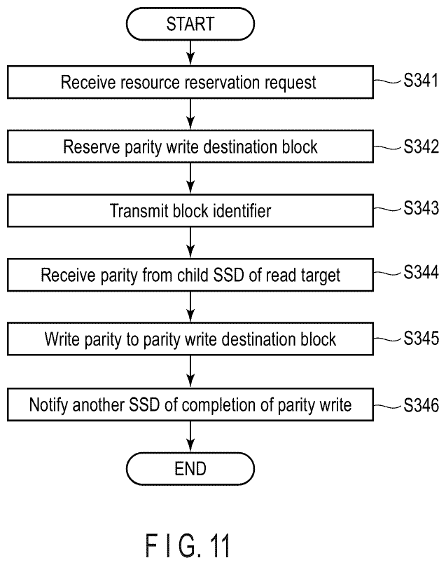

FIG. 11 is a flowchart illustrating an example of the procedure for the third RAID level conversion process executed in the SSD 1. The third RAID level conversion process is a process performed in the parity write target SSD 1 (that is, the child SSD 1 of the parity write target) in the RAID conversion process. The child SSD 1 of the parity write target is the SSD 1 that receives the parity from the child SSD 1 of the read target and stores the parity.

First, the storage control unit 210 of the parity write target SSD 1 receives a resource reservation request from the parent SSD 1 (step S341). The storage control unit 210 reserves a parity write destination block in response to the received resource reservation request (step S342). The storage control unit 210 sends the identifier of the reserved parity write destination block to the parent SSD 1 (step S343).

Next, the storage control unit 210 receives the parity from the child SSD 1 of the read target (hereinafter referred to as the reception source SSD 1) (step 344). The storage control unit 210 writes the received parity to the parity write destination block (step S345). The storage control unit 210 then notifies the reception source SSD 1 that the writing of parity has been completed (step S346), and thus the third RAID level conversion process is finished.

In the above-described third RAID level conversion process, the child SSD 1 of the parity write target receives the parity from the child SSD 1 of the read target, and writes the received parity to the write destination block. Then, the child SSD 1 of the parity write target then notifies the reception source SSD 1 that the writing of the parity that forms the ECC frame has been completed. In response to this notification, the parent SSD 1 and (N−2) child SSDs 1 each perform processing to invalidate the mirror data corresponding to the original data that forms the ECC frame. Therefore, the child SSD 1 of the parity write target can convert the RAID level from RAID1 to RAID5 in cooperation with the parent SSD 1 and the (N−2) child SSDs 1.

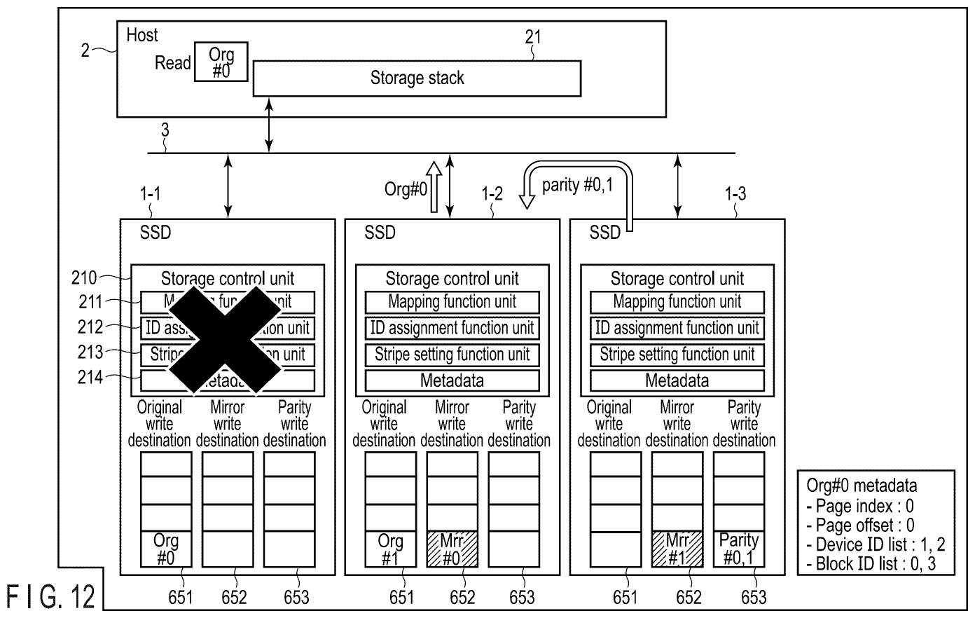

FIG. 12 is a block diagram illustrating the read control processing executed in the SSD 1 according to the third embodiment.

In FIG. 12, such a case is assumed that a read request specifying the logical address of the original data Org #0 stored in the SSD 1-1 is issued while the SSD 1-1 is in failure.

This read request may be issued to any SSD in the SSD array. For example, when the SSD 1-3 receives this read request from the host 2, the storage control unit 210 of the SSD 1-3 specifies the SSD that stores the original data Org #0 (here, SSD 1-1) and the SSD that stores the mirror data Mrr #0 (here, SSD 1-2) by inputting the logical address of the original data Org #0 to the mapping function unit 211. Since the SSD 1-1 is currently in failure, the storage control unit 210 of the SSD 1-3 transfers the received read request to the SSD 1-2, which stores the mirror data Mrr #0.

When this read request is received, the storage control unit 210 of the SSD 1-2 specifies the SSD that stores the original data Org #0 (here, SSD 1-1) and the SSD that stores the mirror data Mrr #0 (here, SSD 1-2) by inputting the logical address of the original data Org #0 to the mapping function unit 211. The SSD 1-1 is currently in failure, and the mirror data Mrr #0 has already been invalidated. However, the storage control unit 210 of the SSD 1-2 retains the metadata of the original data Org #0, and therefore it can read out the data necessary for restoring the original data Org #0 (original data Org #1, parity #0, 1), and restore the original data Org #0 using the original data Org #1 and parity #0, 1. Thus, the storage control unit 210 of the SSD 1-2 can return the restored original data Org #0 to the host 2.

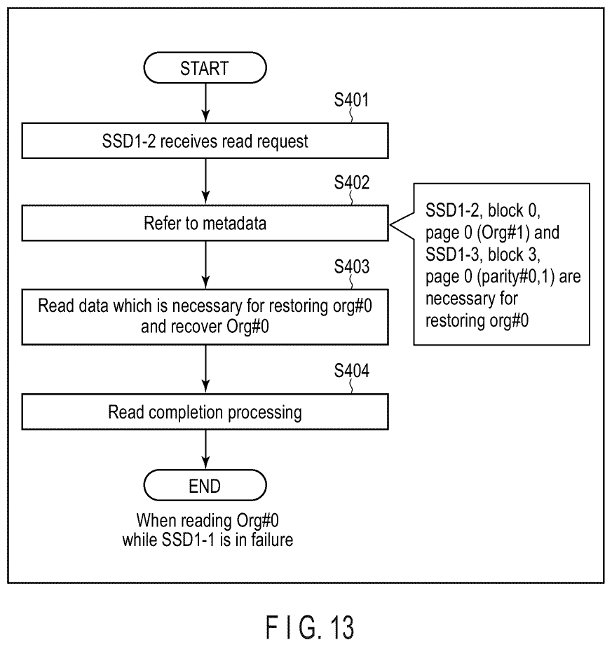

FIG. 13 is a flowchart illustrating an example of the procedure for the read control processing executed in the SSD 1. The read control processing is the process of reading data in response to a read request from the host 2. Here, an example of such a case will be provided that the SSD 1-2 receives a read request for original data Org #0 from the host 2 while the SSD 1-1 is in failure.

First, the storage control unit 210 of the SSD 1-2 receives a read request from the host 2 (step S401). Since the SSD 1-1 is in failure, the storage control unit 210 of the SSD 1-2 refers to the metadata of the original data Org #0 (step S402). Specifically, the storage control unit 210 obtains information from the metadata of the original data Org #0 that (A) the original data Org #1 stored in page 0 of block 0 of the SSD 1-2 and (B) the parity #0, 1 stored in page 0 of block 3 of the SSD 1-3 are required for restoring the original data Org #0.

The storage control unit 210 reads out the data necessary for restoring the original data Org #0 based on the acquired information, and restores the original data Org #0 (step S403). Specifically, the storage control unit 210 reads the original data Org #1 from page 0 of block 0 of the SSD 1-2. The storage control unit 210 sends a request to read data from page 0 of block 3 to the SSD 1-3. The storage control unit 210 receives the parity #0, 1 read in response to this read request from the SSD 1-3. Then, the storage control unit 210 restores the original data Org #0 using the original data Org #1 and the parity data Parity #0, 1.

The storage control unit 210 sends a response indicating that the reading of data in response to the read request has been completed and the restored original data Org #0 to the host 2 (step S404), and thus, the read control process is finished.

According to the third embodiment, advantageous effects similar to those of the first embodiment and also those of the second embodiment can be obtained without providing a storage controller 500. Therefore, the processing load of the host 2 can be greatly reduced.

### Fourth Embodiment

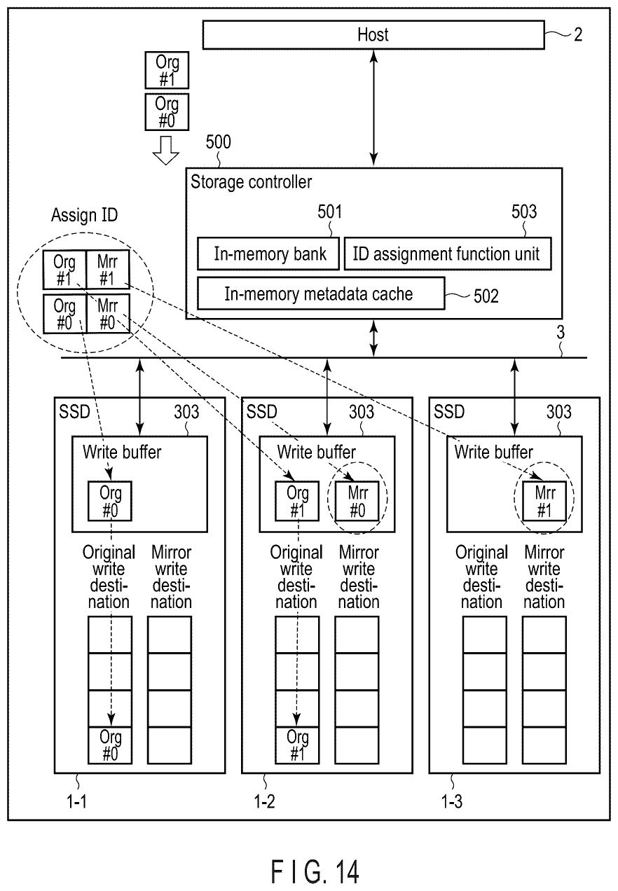

FIG. 14 is a block diagram illustrating an example of the configuration of an information processing system according to the fourth embodiment. The information processing system according to the fourth embodiment includes a host 2, a storage controller 500, and a plurality of SSDs 1 (SSD 1-1, SSD 1-2, and SSD 1-3), as in the cases of the first and second embodiments.

The identifier assignment function unit 503 of the storage controller 500 has a further function of assigning an identifier (the fourth identifier) indicating that the data to be written is data that should be retained in the write buffer 303 of the SSD 1 to a write request that requests the writing of mirror data.

In some cases, the RAID level conversion process is executed immediately after some mirror data are written to one SSD 1 in the SSD array. In this case, each of these mirror data is invalidated.

Therefore, in such a situation, it is preferable from the perspective of reducing write amplification to keep each mirror data in the write buffer 303 without writing it to the mirror write destination block of the NAND flash memory 13.

When a write request is received from the storage controller 500, the memory controllers 11 of each of the SSD 1-1, SSD 1-2, and SSD 1-3 determines whether or not the identifier contained in the received write request is the fourth identifier. In the case where the identifier contained in the received write request is the fourth identifier, the memory controller 11 retains (pins) the data associated with the received write request in the write buffer 303, and does not write this data to the NAND flash memory 13 until the first event occurs. The first event is, for example, the reception of a shutdown request. That is, when receiving a shutdown request from the host 2, the memory controller 11 writes the data (mirror data) retained in the write buffer 303 to the NAND flash memory 13 in order to prevent the data (mirror data) retained in the write buffer 303 from being lost.

In the example of FIG. 14, the write request for the original data Org #0 includes the first identifier and is sent from the storage controller 500 to the SSD 1-1. Therefore, the original data Org #0 is temporarily stored in the write buffer 303 of the SSD 1-1 and then written to the original write destination block of the NAND flash memory 13 of the SSD 1-1.

The write request for the mirror data Mrr #0 contains the fourth identifier, and is sent from the storage controller 500 to the SSD 1-2. For this reason, even after the mirror data Mrr #0 is stored in the write buffer 303 of the SSD 1-2, it is retained in this write buffer 303 and is not written to the NAND flash memory 13 of the SSD 1-2.

The write request for the original data Org #1 contains the first identifier, and is sent from the storage controller 500 to the SSD 1-2. Therefore, the original data Org #1 is temporarily stored in the write buffer 303 of the SSD 1-2 and then written to the original write destination block of the NAND flash memory 13 of the SSD 1-2.

The write request for the mirror data Mrr #1 includes the fourth identifier, and is sent from the storage controller 500 to the SSD 1-3. For this reason, even after the mirror data Mrr #1 is stored in the write buffer 303 of the SSD 1-3, it is retained in this write buffer 303 and is not written to the NAND flash memory 13 of the SSD 1-3.

Note that the configuration of retaining data (mirror data) associated with a write request that includes a fourth identifier in a write buffer can be applied to the third embodiment as well, in which each of the SSDs 1 has a function similar to that of the storage controller 500. In this case, when the memory controller 11 of each SSD 1 transmits a write request for mirror data to another SSD (the SSD of the mirror write target), it assigns the fourth identifier to this write request. Further, in the case where the identifier contained in the write request received from the other SSD is the fourth identifier, the memory controller 11 of each SSD 1 retains the data associated with this received write request (here, mirror data) in the write buffer 303 and does not write the data associated with this received write request (here, mirror data) to the NAND flash memory 13 until an event such as the reception of a shutdown request occurs.

As explained above, according to the first, second, and third embodiments, the original data and mirror data can be written to different blocks. Therefore, even if only the mirror data is invalidated, no fragmentation occurs in the block where these mirror data are stored. In this manner, the frequency at which garbage collection is executed can be reduced, thereby making it possible to reduce write amplification. Further, according to the second and third embodiments, the RAID level can be converted simply by additionally writing the parity to the NAND flash memory 13. Therefore, compared to the case where two or more original data and one parity are additionally written to the SSD array as data for erasure coding, the write amplification can be reduced.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. An information processing system comprising:
a plurality of memory systems; and
a storage controller configured to control the plurality of memory systems,
wherein
the storage controller is configured to:
assign a first identifier and a second identifier to a first write request requesting writing of original data and a second write request requesting writing of mirror data which is a duplicate of the original data, respectively, the first identifier indicating that data to be written is the original data, the second identifier indicating that data to be written is the mirror data;
transmit the first write request including the first identifier to one of the plurality of memory systems; and
transmit the second write request including the second identifier to another one of the plurality of memory systems,
each of the plurality of memory systems comprises:
a nonvolatile memory including a plurality of blocks, each of the plurality of blocks being a unit of a data erase operation; and
a controller configured to control the nonvolatile memory, and
the controller is configured to:
manage a first write destination block to which the original data is to be written and a second write destination block to which the mirror data is to be written;
in response to receiving, from the storage controller, a write request requesting writing of first data, determine whether an identifier contained in the received write request is the first identifier or the second identifier;
in response to determining that the identifier contained in the received write request is the first identifier, write the first data to the first write destination block; and
in response to determining that the identifier contained in the received write request is the second identifier, write the first data to the second write destination block.

2. The system of claim 1, wherein
the storage controller is configured to:
when executing a RAID level conversion process to convert a RAID level for the plurality of memory systems from a level corresponding to mirroring to a level corresponding to erasure coding,
determine three or more memory systems among the plurality of memory systems, the three or more memory systems being used for forming a stripe group;
request a first memory system among the three or more memory systems to reserve a third block to which the original data is already written, as a target block for the RAID level conversion processing;
request a second memory system among the three or more memory systems to reserve a fourth block to which the original data is already written, as a target block of the RAID level conversion process;
request a third memory system among the three or more memory systems to reserve a fifth block, which is a free block;
acquire an identifier of the third block, an identifier of the fourth block, and an identifier of the fifth block from the first memory system, the second memory system, and the third memory system;
read first original data stored in the third block of the first memory system from the third block;
read second original data stored in the fourth block of the second memory system from the fourth block;
calculate first parity information using the first original data and the second original data;
generate a third write request requesting writing of the first parity information;
assign a third identifier to the third write request, the third identifier indicating that data to be written is parity information; and
transmit the third write request including the third identifier to the third memory system, and
the controller of the third memory system is further configured to:
determine whether an identifier included in the third write request received from the storage controller is the first identifier, the second identifier, or the third identifier; and
in response to determining that the identifier contained in the third write request is the third identifier, write the first parity information to the fifth block.

3. The system of claim 2, wherein
the storage controller is further configured to:
manage metadata of the first original data; and
after the writing of the first parity information to the fifth block is completed, update the metadata of the first original data by adding first stripe group information and logical-to-physical address translation information corresponding to the first original data, to the metadata of the first original data, the first stripe group information including a list of identifiers of the three or more memory systems that form the stripe group and a list of identifiers of the blocks each reserved in the three or more memory systems.

4. The system of claim 2, wherein
the storage controller is further configured to:
after the writing of the first parity information to the fifth block is completed,
transmit a first invalidation request specifying a first logical address corresponding to the first original data to one memory system among the plurality of memory systems, the one memory system being a memory system in which the first mirror data corresponding to the first original data is stored; and
transmit a second invalidation request specifying a second logical address corresponding to the second original data to another memory system among the plurality of memory systems, said another memory system being a memory system in which the second mirror data corresponding to the second original data is stored.

5. The system of claim 1, wherein
the controller of each of the plurality of memory systems is further configured to allocate a block among the plurality of blocks as the second write destination block, the allocated block having a durability for data rewriting that is higher than a first value.

6. The system of claim 1, wherein
the storage controller is further configured to:
assign a fourth identifier to the second write request, the fourth identifier indicating that the data to be written is data to be retained in a write buffer; and
transmit the second write request including the fourth identifier to said another one of the plurality of memory systems,
each of the plurality of memory systems further includes a write buffer, and
the controller of each of the plurality of memory systems is further configured to:
determine whether an identifier contained in the received write request is the fourth identifier; and
in response to determining that the identifier contained in the received write request is the fourth identifier, retain the first data in the write buffer and not write the first data to the nonvolatile memory until a first event occurs.

7. The system of claim 6, wherein
the first event includes receiving of a shutdown request.

8. The system of claim 1, wherein
the storage controller is connectable to a host, and
the original data is data specified by a write request from the host.

9. A memory system connectable to each of a host and two or more other memory systems, the memory system comprising:
a nonvolatile memory including a plurality of blocks, each of the plurality of blocks is a unit of data erase operation; and
a controller configured to control the nonvolatile memory,
wherein
the controller is configured to:
manage a first write destination block to which original data is to be written and a second write destination block to which mirror data is to be written, the mirror data being a duplicate of the original data;
in response to receiving, from the host, a first write request requesting writing of first data, determine a first write destination memory system to which the first data is to be written and a second write destination memory system to which mirror data, which is a duplicate of the first data, is to be written, from among the plurality of memory systems including the memory system and two or more other memory systems, based on a logical address specified by the first write request;
in response to that the memory system is determined as the first write destination memory system, write the first data to the first destination block, assign a second identifier to the first write request, the second identifier indicating that data to be written is the mirror data, and transfer the first write request including the second identifier to another memory system determined as the second destination memory system;
in response to that the memory system is determined as the second write destination memory system, write the first data to the second destination block, as the mirror data of the first data, assign a first identifier to the first write request, the first identifier indicating that data to be written is the original data, and transfer the first write request including the first identifier to another memory system determined as the first write destination memory system; and
in response to determining that the memory system is neither the first destination memory system nor the second destination memory system, assign the first identifier to the first write request, transfer the first write request including the first identifier to another memory system determined as the first write destination memory system, assign the second identifier to the first write request, and transfer the first write request including the second identifier to still another memory system determined as the second write destination memory system.

10. The system of claim 9, wherein
the controller is furtherer configured to:
in response to receiving a second write request from one of the two or more other memory systems,
determine whether an identifier contained in the second write request is the first identifier or the second identifier;
in response to determining that the identifier contained in the second write request is the first identifier, write second data associated with the second write request to the first write destination block; and
in response to determining that the identifier contained in the second write request is the second identifier, write the second data to the second write destination block.

11. The system of claim 9, wherein
the controller includes a mapping function that uniquely determines, based on a logical address input, a write destination memory system with a highest priority and a write destination memory system with a next highest priority from among the plurality of memory systems, and is further configured to determine the first write destination memory system and the second write destination memory system by inputting the logical address specified by the first write request.

12. The system of claim 9, wherein
the controller is further configured to:
in a case where the memory system operates as a device for starting RAID level conversion processing to convert a RAID level for the plurality of memory systems from a level corresponding to mirroring to a level corresponding to erasure coding,
determine three or more memory systems among the plurality of memory systems, the three or more memory systems being used for forming a stripe group, the memory system being included in the three or more memory systems as a first memory system among the three or more memory systems;
reserve a block in which the original data is already written, among the plurality of blocks of the nonvolatile memory of the memory system;
request a second memory system of the three or more memory systems to reserve a fourth block in which the original data is already written, among the plurality of blocks of the nonvolatile memory of the second memory system;
request a third memory system of the three or more memory systems to reserve a fifth block, which is a free block, among the plurality of blocks of the nonvolatile memory of the third memory system;
obtain an identifier of the fourth block and an identifier of the fifth block from the second memory system and the third memory system;
transmit first stripe group information including a list of identifiers of the three or more memory systems that form the stripe group and a list of identifiers of blocks reserved respectively in the three or more memory systems, to the second memory system and the third memory system, respectively;
read first original data stored in the third block of the memory system, from the third block; and
transmit the first original data to the second memory system, and
the second memory system is configured to:
calculate first parity information using the first original data and second original data, the second original data being stored in the fourth block of the second memory system; and
transmit the first parity information to the third memory system.

13. The system of claim 12, wherein
the controller is further configured to:
in a case where the second memory system operates as the device for starting the RAID level conversion process,
receive second original data from the second memory system, the second original data being data that is read from the fourth block by the second memory system;
calculate the first parity information using the second original data and first original data, the first original data being data that is stored in the third block of the memory system; and
transmit the first parity information to the third memory system.

14. The system of claim 12, wherein
the controller is further configured to:
after receiving a notification from the second memory system, the first notification indicating that writing of the first parity information to the fifth block of the third memory system is completed, generate first metadata for the first original data, the first metadata including the first stripe group information and logical-to-physical address translation information corresponding to the first original data;
identify one memory system among the plurality of memory systems, the one memory system being a memory system in which first mirror data corresponding to the first original data is stored; and
transmit the first metadata to the identified memory system so that the identified memory system retains the first metadata.

15. The system of claim 12, wherein
the controller is further configured to:
after receiving a notification from the second memory system, the notification indicating that writing of the first parity information to the fifth block of the third memory system is completed,
transmit a first invalidation request specifying a first logical address corresponding to the first original data to one memory system among the plurality of memory systems, the one memory system being a memory system in which first mirror data corresponding to the first original data is stored.

16. The system of claim 9, wherein
the controller is further configured to:
when transferring the first write request to said another memory system determined as the second destination memory system,
assign a fourth identifier to the first write request, the fourth identifier indicating that the data to be written is data to be retained in a write buffer to the first write request; and
transmit the first write request including the fourth identifier, to said another memory system determined as the second destination memory system, and
said another memory system determined as the second destination memory system further includes a write buffer and is configured to:
determine whether an identifier contained in the first write request is the fourth identifier; and
in response to determining that the identifier contained in the first write request is the fourth identifier, retain the first data in the write buffer and not write the first data to the nonvolatile memory until a first event occurs.
